(19) United States
(12) Patent Application Publication
(10) Pub. No.: US 2026/0289264 A1
(43) Pub. Date: Sep. 24, 2026

(54) SYSTEM

(71) Applicant: SoftBank Group Corp., Tokyo (JP)

(72) Inventor: Norihiro FUKE, Tokyo (JP)

(73) Assignee: SoftBank Group Corp., Tokyo (JP)

(21) Appl. No.: 19/565,558

(22) Filed: Mar. 13, 2026

(30) Foreign Application Priority Data
Mar. 19, 2025 (JP) 2025-045028

(51) Int. Cl. G06N 3/0475; G06F 3/01; G06F 3/0482; G06F 3/0486

(52) U.S. Cl. CPC G06N 3/0475; G06F 3/011; G06F 3/0482; G06F 3/0486; G06F 2203/011

(57) ABSTRACT

A system includes a processor, that is configured to provide a user interface for displaying, in a list format, information on activities and destinations that a user inputs by using an information processing device, execute an algorithm that allows the user to change an order of items in the list by drag-and-drop and that automatically generates a plan based on a changed order, and input a prompt sentence into a generative AI model to analyze past behavior patterns of the user and optimize the plan.

### CROSS-REFERENCE TO RELATED APPLICATION

This application is based on and claims priority under 35 USC 119 from Japanese Patent Application No. 2025-045028 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Users often create personal plans that include various activities and destinations, such as errands, leisure activities, and visits to specific places. However, conventional planning tools generally require the user to manually arrange and revise schedules without effectively utilizing the user's past behavior patterns, priorities, or current schedule. As a result, the user must repeatedly adjust item orders and time allocations, which is time-consuming and may lead to suboptimal plans that do not reflect actual habits or constraints. Furthermore, although generative AI models have advanced in their ability to process natural language and generate useful suggestions, typical systems do not effectively leverage such models by means of prompt-based interaction to analyze user behavior logs, optimize plans, and propose suitable time slots for activities. Consequently, there is a need for a system that can: (i) provide an intuitive list-based interface that allows a user to simply reorder items, (ii) automatically generate and optimize a plan based on the changed order and past behavior patterns, and (iii) propose optimal time slots by using a generative AI model through appropriate prompts.

### SUMMARY

To solve the above problems, the present invention provides a system comprising a processor, wherein the processor is configured to provide a user interface for displaying, in a list format, information on activities and destinations that a user inputs by using an information processing device, execute an algorithm that allows the user to change an order of items in the list by drag-and-drop and that automatically generates a plan based on a changed order, and input a prompt sentence into a generative AI model to analyze past behavior patterns of the user and optimize the plan.

In one aspect, the processor is configured to generate the prompt sentence for the generative AI model and input the prompt sentence into the generative AI model in order to learn behavior patterns and priorities of the user. By doing so, the system enables the generative AI model to infer which types of activities or destinations are typically preferred at particular times or under certain conditions, and to reflect such inferred patterns in the optimization of the generated plan.

In another aspect, the processor is configured to generate the prompt sentence for the generative AI model and input the prompt sentence into the generative AI model in order to propose an optimal time slot based on a schedule of the user and items in the list. By combining the user's schedule, the list items, and the generative AI model's reasoning capabilities through the generated prompts, the system can propose specific time periods for executing selected activities or visiting destinations, thereby reducing the user's burden of manual scheduling and improving the suitability and practicality of the resulting plan.

The term “system” refers to an arrangement comprising at least one processor and, optionally, one or more information processing devices and user interfaces, which cooperatively perform the operations described in the claims.

The term “processor” refers to one or more hardware-based processing units, such as a central processing unit (CPU), a microprocessor, or a set of such units, configured to execute instructions and algorithms to implement the functionalities defined in the claims.

The term “information processing device” refers to any device capable of inputting, transmitting, receiving, or displaying digital information, including but not limited to a smartphone, tablet, personal computer, wearable device, or similar electronic apparatus used by the user.

The term “user interface” refers to a software and/or hardware interface through which the user can view information and perform operations, including displaying a list of items and receiving user input actions such as drag-and-drop.

The term “list format” refers to a display style in which multiple items, such as activities or destinations, are presented as a series of entries arranged in a certain order, typically vertically or horizontally, and individually selectable or manipulable by the user.

The term “activity” refers to any action or task that the user intends to perform, such as exercising, studying, shopping, or other personal or work-related tasks.

The term “destination” refers to any place or location that the user intends to visit, such as a store, office, park, library, or other physical venue.

The term “plan” refers to a structured arrangement of one or more items, including activities and/or destinations, and optionally associated execution orders, priorities, and time-related information, which represents the user's intended schedule or agenda.

The term “item” refers to an individual entry in the list that corresponds to an activity or a destination, and that can be reordered, analyzed, or scheduled by the system.

The term “drag-and-drop” refers to a user input operation in which the user selects an item in the user interface, moves (drags) the item to a different position within the list by a pointing action or touch operation, and then releases (drops) the item to change the order of items in the list.

The term “algorithm” refers to a sequence of machine-executable steps or instructions implemented by the processor to process data, including but not limited to generating a plan, changing item order, analyzing behavior patterns, and optimizing or proposing time slots.

The term “generative AI model” refers to a machine learning model, such as a large language model or other generative model, that has been trained on data to generate outputs, including text, responses, or recommendations, based on input prompts provided by the processor.

The term “prompt sentence” refers to a text-based input, or a set of text-based inputs, generated and provided by the processor to the generative AI model, which describes a task, context, or query so that the generative AI model can produce a corresponding output.

The term “past behavior patterns” refers to recurring tendencies or habits of the user, inferred from historical data such as executed activities, visited destinations, times of execution, frequencies, and related contextual information.

The term “optimize the plan” refers to the process of modifying or refining a plan so that it better matches the user's behavior patterns, priorities, constraints, or objectives, for example by adjusting the order of items or suggesting more suitable times for execution.

The term “behavior patterns and priorities” refers to the user's typical ways of choosing and performing activities or visiting destinations, including preferred times, frequencies, and relative importance assigned to different items.

The term “schedule of the user” refers to time-related information indicating periods during which the user is busy or free, including appointments, meetings, events, or other time allocations, which are used by the system when proposing an optimal time slot.

The term “optimal time slot” refers to a time period proposed by the system for executing a particular item, which is determined based on at least the user's schedule, list items, and behavior patterns, and which is intended to be suitable or preferable for the user compared to other possible time periods.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

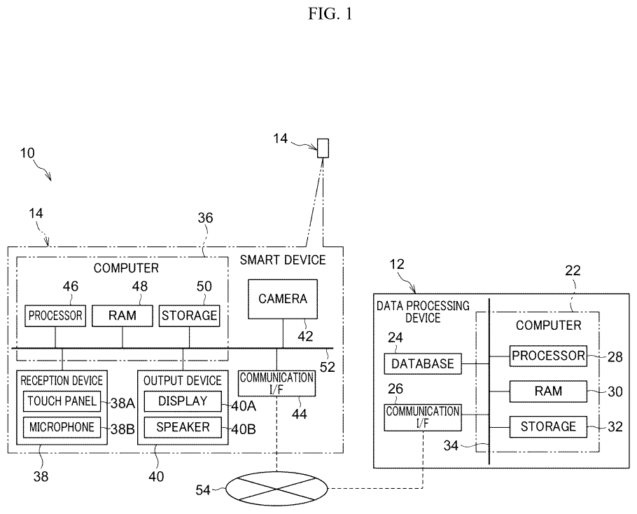

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

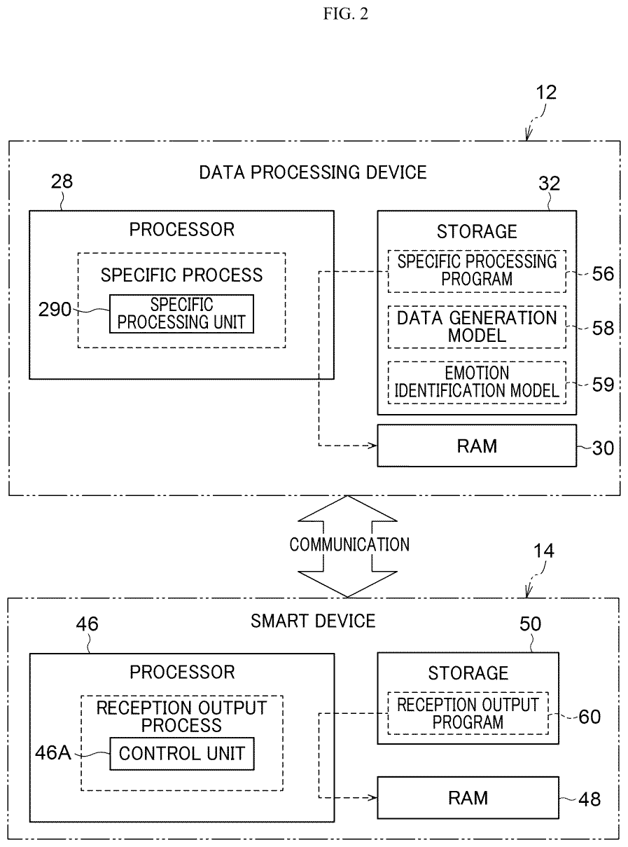

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional scheduling and planning systems typically generate time schedules by applying fixed heuristic rules or simple constraint solvers to user-provided lists of activities. In such systems, a processor generally treats an activity list as static input and assigns times based on predefined templates or generic rules without fully leveraging long-term behavioral data of the individual user. As a result, several technical problems arise in terms of computer functionality, data processing efficiency, and system-level adaptability.

First, conventional systems do not provide a structured mechanism for converting free-form user input and historical execution logs into a unified, machine-understandable representation that can be directly consumed by an intelligent model. User behavior patterns such as typical stay durations, preferred start time ranges, and preferred time zones for different classes of activities are often stored as unstructured or loosely structured records. Without transforming these heterogeneous data into an integrated, semantically rich prompt sentence suitable for an artificial intelligence model, the processor cannot effectively use the computational capabilities of a generative AI model to improve schedule quality. This results in a technical limitation where the computer system merely retrieves and displays historical data, instead of computationally synthesizing optimized plans.

Second, when generative AI models are used in a naive way, the processor may send incomplete or inconsistent context to the model, such as only the current list of activities without rigorous temporal constraints, ordering constraints, or quantified behavior patterns. In such cases, the generated output may violate user-defined order, produce overlapping or invalid time ranges, or ignore system-level constraints such as a daily allowable window. This leads to additional post-processing overhead, increased error correction, and unpredictable system behavior, thereby degrading the technical reliability and determinism of the scheduling process.

Third, conventional systems that allow drag-and-drop reordering on a user interface typically handle only front-end reordering logic and then pass a minimally structured representation to the back-end. They do not maintain a robust pipeline in which the updated order information is combined with behavior pattern data and constraints, encoded as a structured natural language prompt, and then validated and corrected after model inference. Accordingly, the system is not able to systematically integrate interactive user input and AI-driven optimization, leading to suboptimal utilization of computational resources and inconsistent user experiences.

Fourth, there is a lack of mechanisms for automated, iterative re-optimization that respond to user edits of an already optimized plan. When a user changes the order or constraints after a schedule has been generated, conventional systems generally recalculate using the same static heuristic rules. They do not generate refined prompt sentences that incorporate both updated user input and accumulated behavior patterns, and therefore cannot exploit the generative AI model to continuously refine the schedule. This results in a system that cannot adaptively improve its outputs over time from a data processing perspective.

Accordingly, there is a need for a computer-implemented technique that (i) structurally integrates user-defined ordered activity lists, baseline schedules, and statistically aggregated behavior patterns, (ii) automatically generates detailed prompt sentences containing explicit temporal and ordering constraints for a generative AI model, (iii) validates and deterministically corrects the AI-generated schedule to meet format and constraint requirements, and (iv) supports iterative re-optimization in response to subsequent user edits. By addressing these issues, the invention aims to improve the technical functioning of scheduling systems on a processor, including improved use of storage, reduced inconsistency in generated schedules, and enhanced reliability and efficiency of AI-assisted schedule generation.

The specific processing by the specific processing unit 290 of the data processing device 12 in Example 1 is realized by the following means.

The present invention provides a server comprising at least one processor and at least one memory storing instructions that, when executed by the at least one processor, cause the server to provide, to a general-purpose information processing apparatus, a user interface enabling a user to input activity information or movement information as text data, convert the text data into structured data with order information, and display the structured data as list information; detect drag-and-drop operations performed by the user on the list information, update the order information of the structured data in response to the drag-and-drop operations, and automatically generate a baseline plan by calculating, with a time information calculation library, a start time and an end time for each activity based on the updated order information such that the baseline plan is non-overlapping and falls within a predetermined time range; acquire, from a storage device, the baseline plan and past execution history data associated with the user, and aggregate, based on the past execution history data, behavior pattern information including tendency information of stay duration, tendency information of start time, and preferred time zone information for each type of activity; generate a prompt sentence including the list information, the baseline plan, and the behavior pattern information, describe, in natural language within the prompt sentence, a user-defined order maintenance condition, a predetermined time range constraint, and a waiting-time reduction condition, and input the prompt sentence into a generative AI model to obtain, from the generative AI model, an optimized plan including optimized start times and end times corresponding to the activities; verify that an order of the activities included in the optimized plan matches the user-defined order and that time information included in the optimized plan satisfies a predetermined format and the predetermined time range constraint and does not mutually overlap, perform deterministic time correction processing to resolve any inconsistency, and store, in the storage device, a verified optimized plan; and acquire the verified optimized plan, present the verified optimized plan on a display device of the general-purpose information processing apparatus in a time-axis display or a list display, and, in response to acceptance of a re-editing operation of the verified optimized plan from the user, generate, together with updated behavior pattern information, a new prompt sentence based on updated plan information for re-input to the generative AI model and execute a re-optimization process. This enables the computer system to transform heterogeneous user inputs and historical behavioral data into a unified, constrained representation for a generative AI model, to systematically validate and correct the model's output at the system level, and to iteratively refine schedules in response to user interactions, thereby improving the technical performance, reliability, and efficiency of AI-assisted schedule generation on the server.

The term “general-purpose information processing apparatus” refers to an electronic computing device, such as a smartphone, tablet, notebook computer, desktop computer, or similar programmable device, that is capable of executing application software, presenting a graphical user interface, and communicating with a server over a communication network.

The term “user interface” refers to a software-implemented interaction mechanism presented on a display device of a general-purpose information processing apparatus, including screens, input fields, buttons, and graphical components, through which a user can input data, view information, and perform operations such as drag-and-drop.

The term “activity information” refers to data representing a planned task, event, or action to be performed by a user, including at least a textual description (for example, a label or title) and optionally additional attributes such as category, expected duration, or location.

The term “movement information” refers to data representing a planned transition of a user between locations or destinations, including at least a textual description of the destination and optionally attributes such as travel mode, estimated travel time, or preferred arrival window.

The term “text data” refers to character-based information entered by a user via an input component of the user interface, including plain text strings representing activities or destinations, which can be processed by the system as input for further conversion or analysis.

The term “structured data” refers to data that has been converted from free-form text into a machine-readable format with defined fields or attributes, such as identifiers, titles, categories, durations, and order information, that can be programmatically processed by the processor.

The term “order information” refers to data indicating the relative or absolute sequence of multiple activities or items within a list, such as index values or sequence numbers, used by the processor to determine and maintain the user-defined order.

The term “list information” refers to a structured grouping of multiple activity information or movement information items, each associated with order information, which is displayed in a list format on the user interface and can be manipulated by the user.

The term “drag-and-drop operation” refers to a user interaction in which the user selects a displayed item on the user interface, moves the item to a different position using a pointing or touch device, and releases the item to update its position in the list information.

The term “baseline plan” refers to an initially generated schedule constructed by the processor based on the user-defined order and default or rule-based duration and timing, including start times and end times for each activity, and satisfying predetermined constraints such as non-overlap and time range.

The term “time information calculation library” refers to a software component or set of functions executed by the processor that performs operations on temporal data, including parsing time values, adding durations, comparing times, and checking time range constraints.

The term “predetermined time range” refers to a time interval defined by configuration data or user preferences, such as a daily allowable scheduling window, within which the start times and end times of activities in a plan are constrained to remain.

The term “storage device” refers to a physical or logical data storage resource, such as a solid-state drive, magnetic disk, or network-accessible database system, used to persistently store plans, historical execution data, and behavior pattern information.

The term “past execution history data” refers to recorded information about previously generated plans and their actual execution by the user, including scheduled times, actual start and end times, completion status, user feedback, and related metadata.

The term “behavior pattern information” refers to derived data representing tendencies or statistical regularities in a user's historical behavior, including tendencies of stay duration, tendencies of start time, and preferred time zone information for each type of activity.

The term “tendency information of stay duration” refers to statistical indicators, such as averages or distributions, of how long a user typically remains engaged in a given type of activity, computed from past execution history data.

The term “tendency information of start time” refers to statistical indicators of when a user typically starts a given type of activity, expressed as preferred start time points or time ranges, computed from past execution history data.

The term “preferred time zone information” refers to time intervals during a day or other period in which a user is more likely to perform or prefers to perform certain types of activities, derived from analysis of past execution history data.

The term “prompt sentence” refers to a natural language expression or sequence of expressions, optionally combined with structured data, generated by the processor to describe context, constraints, and objectives, and supplied as input to a generative AI model.

The term “generative AI model” refers to a machine-learned model, such as a large language model or similar neural network-based model, that receives a prompt sentence and produces generated output, including text or structured data, by probabilistic inference over learned parameters.

The term “optimized plan” refers to a schedule generated by the generative AI model in response to a prompt sentence and processed by the processor, in which start times and end times of activities are adjusted according to behavior pattern information and specified constraints to improve efficiency or suitability for the user.

The term “user-defined order” refers to the sequence of activities or items as explicitly determined or confirmed by the user, for example, through drag-and-drop operations on the user interface, and which the system is required to respect when generating or optimizing a plan.

The term “predetermined format” refers to a fixed representation rule for expressing time or schedule information, such as a specific time notation (for example, HH:MM) or structured field layout, which generated or optimized plans must conform to.

The term “waiting-time reduction condition” refers to a constraint or objective encoded in a prompt sentence or internal logic that encourages the minimization of idle gaps or unnecessary intervals between consecutive scheduled activities.

The term “deterministic time correction processing” refers to rule-based, non-stochastic adjustment operations performed by the processor on time values within a generated plan to resolve overlaps, format errors, or constraint violations in a predictable and reproducible manner.

The term “verified optimized plan” refers to an optimized plan that has been subjected to validation and, if necessary, deterministic time correction processing, and has been confirmed by the processor to meet order constraints, non-overlap conditions, time range constraints, and formatting requirements.

The term “time-axis display” refers to a visual representation of schedule information arranged along a temporal axis, such as a timeline or calendar view, in which activities are displayed according to their start times and end times.

The term “list display” refers to a visual representation in which scheduled activities are displayed as a sequence of items, typically in textual or tabular form, showing at least activity identifiers and corresponding time information.

The term “re-editing operation” refers to user interactions performed after a plan has been generated or optimized, including changing the order of activities, modifying time preferences, adding or removing activities, or adjusting constraints via the user interface.

The term “behavior pattern summary information” refers to a natural language representation of behavior pattern information, including key statistical tendencies and preferences, formatted for inclusion in a prompt sentence to be processed by a generative AI model.

The term “priority information” refers to data indicating relative importance or preference among multiple activities or items, which may influence how the system allocates time slots or resolves conflicts when generating or optimizing a plan.

The term “constraint duration information” refers to data specifying required or limited durations for particular activities or groups of activities, such as minimum or maximum allowable time lengths to be honored in the scheduling process.

The term “prohibited time zone information” refers to data specifying time intervals during which certain activities should not be scheduled, such as user-defined blackout periods or system-defined unavailable periods.

The term “schedule information of the user” refers to data describing the user's existing or planned commitments, including appointments, tasks, or other time-occupied intervals, which must be considered when proposing or optimizing new activity times.

The term “list items” refers to individual entries within the list information, each corresponding to a single activity or movement, and each associated with attributes such as title, order information, and optional constraints.

In the following, a data processing apparatus is referred to as a “server,” a user-operated computing device is referred to as a “terminal,” and an operator is referred to as a “user.”

The server uses one or more general-purpose processors, such as multi-core central processing units, optionally in combination with graphics processing units, mounted in a computing platform such as a rack-mounted computer, a virtual machine in a data center, or a cloud instance. The server uses a main memory device, a persistent storage device such as a solid-state drive or magnetic disk, and a communication interface coupled to a communication network. The server executes server-side software implemented, for example, using an operating system, a web application framework, a database management system, and a library for communication with an external generative AI model. The server executes application logic written in a programming language such as a compiled language or an interpreted language.

The terminal uses hardware such as a smartphone, a tablet device, or a notebook computer, equipped with a display device, a pointing device or touch panel, and a communication interface. The terminal executes an application, for example, a native mobile application or a web browser application that loads client-side scripts. The terminal uses a graphical user interface library, such as a mobile interface framework or a web-based component library, to draw screens and receive input events.

The user operates the terminal to launch a scheduling application. The terminal draws an input screen including one or more text boxes, list widgets, and operation buttons. The terminal allocates a memory region to maintain an internal list of activities as structured data, for example, an array of records each comprising at least an identifier field, a title field, an optional category field, a default duration field, and an order index field. The terminal converts each text string typed by the user into such a record. The terminal stores these records locally in volatile memory and optionally in a local storage region.

The terminal presents the records as list information on the display. The terminal uses a list component that supports drag-and-drop. The terminal associates each visual list item with a corresponding record in memory via an index or a pointer. When the user performs a drag-and-drop operation on the display, the terminal detects low-level events (press, move, release) and maps them to a change in the order index field maintained in the structured data. The terminal updates the array so that the internal order information reflects the new user-defined sequence.

The terminal communicates the updated structured data to the server via the communication network. The terminal prepares a message body that includes the user identifier, the list of activities in the current order, and optional constraint parameters such as a preferred daily time range or an initial reference date. The terminal sends this message to the server using a secure network protocol. The terminal receives, from the server, information representing a baseline plan and an optimized plan, and displays these plans as a time-axis display or a list display. The terminal uses interface elements such as timeline bars or table rows to represent each planned activity with its start time and end time. The terminal also allows the user to apply further re-editing operations to the plan, such as changing priority flags or adjusting forbidden time ranges.

The server receives messages from the terminal and stores activity information in a structured data store. The server uses a database management system such as a relational database or a NoSQL storage system to maintain tables or collections representing users, activities, baseline plans, optimized plans, and historical execution logs. The server persists each activity with fields including at least a user identifier, an activity identifier, a textual label, optional category metadata, default or actual duration values, user-defined order index, and timestamps.

The server implements a baseline scheduling engine. The server reads the list information from the database or from the received message, together with user-specific configuration such as a daily allowable time range. The server applies a deterministic algorithm using a time information calculation library to compute a baseline plan. The server, for each activity in order, computes a start time by scanning from a current pointer time and skipping over occupied or forbidden intervals derived from existing schedule information of the user. The server then computes an end time by adding a duration associated with the activity. The server stores the resulting baseline plan as a set of records comprising at least an activity identifier, the computed start time, the computed end time, and a plan identifier.

The server collects past execution history data for the same user. The server queries the storage device for records of past baseline and optimized plans as well as execution logs recording actual start and end times, completion status, and user feedback. The server aggregates this data to compute behavior pattern information. The server, for each type of activity or activity category, computes statistical measures such as average stay duration, median stay duration, variance, preferred start time distribution, and distribution of activity occurrences across different time zones in a day. The server may use numerical libraries to compute these statistics efficiently. The server normalizes the statistics to avoid overfitting to outliers, for example by clipping or smoothing extreme values.

The server converts behavior pattern information into a behavior pattern summary. The server transforms statistical arrays into natural language descriptions that are concise yet structured. For example, the server may generate a description such as “The user usually spends about 90 minutes at cafe-type activities, starts movie-type activities between 13:00 and 15:00, and prefers outdoor walking-type activities after 17:00.” The server builds this description by applying templates and inserting computed statistical values rounded to meaningful units.

The server constructs a prompt sentence for a generative AI model. The server concatenates three types of content: (i) a representation of the current ordered activity list, (ii) a description of the baseline plan including start and end times, and (iii) the behavior pattern summary. The server adds explicit constraint statements describing a user-defined order maintenance condition, a predetermined time range constraint, a waiting-time reduction condition, and any additional constraints such as prohibited time zones or required durations. The server arranges this information in a deterministic sequence so that the same input context yields a consistent prompt representation, which improves reproducibility of the generative AI model output.

The server may construct, for example, a prompt sentence in the following form:

“User-defined ordered activities: 1) go to a cafe, 2) watch a movie, 3) take a walk in the park.

Baseline schedule:
go to a cafe: 10:00-11:00
watch a movie: 13:00-15:00
take a walk in the park: 16:30-17:15

User behavior patterns: the user usually spends about 90 minutes at cafe-type activities, prefers movies in the early afternoon, prefers walks after 17:00, and dislikes long idle gaps between activities.

Constraints: respect the user-defined order strictly; keep all activities between 09:00 and 21:00; minimize idle time between consecutive activities; do not overlap activities.

Generate an optimized one-day plan that adjusts specific start times and end times for each activity. Output the result with each line formatted as ‘HH:MM-HH:MM: activity’.”

The server sends this prompt sentence to a generative AI model. In one embodiment, the generative AI model is a large language model implemented as a multi-layer transformer neural network. The model includes an embedding layer that converts tokens of the prompt sentence into dense feature vectors, a stack of self-attention and feed-forward layers that compute contextualized representations, and an output layer that produces probability distributions over tokens. The server accesses the generative AI model via an application programming interface provided by an AI service or via an internal deployment on a specialized computing node with accelerators.

The server configures the generative AI model parameters such as decoding temperature, maximum output length, and penalty terms for repetition, to achieve stable and constrained outputs. The server uses a decoding strategy such as constrained beam search or nucleus sampling with post-filtering, with rules that enforce inclusion of required activity names and discourage violations of time format. Thus, the server does not rely on unstructured free generation but constrains the output distribution to match the technical requirements of schedule generation.

The server receives the generated text from the generative AI model and parses the output. The server applies a formal grammar or regular expressions to extract time expressions and activity labels. The server converts each extracted time into a machine-readable time object using the time information calculation library. The server builds an internal representation of an optimized plan, using data structures that mirror those of the baseline plan, but with time fields sourced from the generative AI output.

The server carries out verification and deterministic time correction. The server checks that the order of activities in the optimized plan matches the user-defined order by comparing activity identifiers or labels. The server verifies that each start time and end time falls within the predetermined time range. The server also checks for overlapping intervals by comparing end times of preceding activities with start times of subsequent activities. If the server detects small overlaps or boundary violations, the server applies a deterministic correction algorithm, such as shifting start times forward or compressing idle gaps, following a fixed rule set. Because these corrections are deterministic and based on well-defined constraints, the server guarantees that the same input set yields the same corrected schedule.

The server persists the verified optimized plan in the storage device, marking each record with a flag that indicates that behavior pattern information and generative AI optimization have been applied. The server maintains links between the initial baseline plan and the optimized plan, enabling comparison and auditing. The server can log intermediate representations such as prompt sentences and raw model outputs to a log storage system for debugging or future model retraining, in compliance with privacy and security constraints.

The server provides the verified optimized plan to the terminal. The server packages the plan into a message containing, at a minimum, activity identifiers, textual labels, start times, end times, and optional annotations describing improvements compared to the baseline. The terminal displays this information, enabling the user to visually perceive how the schedule has been adjusted to align with personal behavior patterns. The terminal may present side-by-side views of baseline and optimized plans or highlight intervals where idle time or overlaps have been reduced.

The user may perform re-editing operations on the optimized plan. For example, the user may change the priority of an activity, add a forbidden time period, or insert a new activity. The terminal updates local structured data to reflect these changes and transmits updated plan information and constraint parameters to the server. The server then updates behavior pattern information as needed and constructs a new prompt sentence that incorporates both the updated plan and refined statistical data. In this manner, the server repeatedly uses a structured pipeline to request further optimization from the generative AI model, rather than re-running only a simple heuristic rule set.

By structuring heterogeneous data user text input, historical execution logs, and schedule constraints into unified structured data and a detailed prompt sentence, the server improves data management efficiency. The server eliminates ad hoc rule scattering across the codebase, centralizing constraints in the prompt construction and verification modules. This architecture improves maintainability and reduces the computational overhead of re-implementing complex heuristics, since the generative AI model performs high-dimensional pattern exploitation while the server ensures constraint satisfaction.

The described configuration yields technical effects beyond mere automation of human mental planning. The server reduces computational complexity relative to brute-force constraint solving for large activity sets by using learned priors encoded in the generative AI model to propose near-feasible solutions, and then applying only lightweight deterministic corrections. This hybrid approach can reduce the average number of iterations needed to arrive at a valid schedule, thereby decreasing processor time and network traffic between the server and storage device. Furthermore, because the server encodes user behavior patterns as statistical features and constraints, the generated schedules exhibit higher alignment with actual user habits, reducing the number of subsequent manual edits and thus decreasing the volume of interaction messages between the terminal and server.

In one embodiment, the generative AI model is trained by supervised learning with a training corpus that includes pairs of input contexts (activity lists, baseline schedules, behavior pattern summaries) and high-quality expert schedules. The server or a training system uses an error function measuring differences between generated times and target expert times, such as mean squared error over normalized time positions, augmented with penalties for order violations and overlapping activities. The training system updates model parameters by backpropagation with an optimizer such as stochastic gradient descent or an adaptive method. Data augmentation techniques such as time shifting, random insertion of idle intervals, and synthetic generation of user behavior profiles are applied to improve generalization. As a result, the deployed model encodes non-trivial scheduling knowledge in its parameters, beyond what could be manually programmed as simple rules.

In another embodiment, the server maintains multiple generative AI models or multiple configuration profiles of a single model. The server can select between these based on device characteristics, user preferences, or constraints on processing latency. For example, a compact model may be used when low latency is required, and a larger model may be used asynchronously for more complex daily plans, with the terminal receiving a later refinement. The server may also cache model outputs for frequently occurring patterns, further reducing computation and communication overhead.

The described system thus improves computer technology itself by defining a specific data structure pipeline, a structured prompt construction technique, and a validation and correction module that cooperate with a generative AI model. These components collectively enhance the precision of generated schedules, reduce processing time and network traffic, and provide deterministic, reproducible behavior in the presence of probabilistic model outputs. The use of the generative AI model is not a generic invocation of an abstract “model,” but a controlled interaction that leverages specific neural network architecture and training procedures together with non-conventional rule-based post-processing within the server. This configuration yields a technical solution in which the server, the terminal, and the generative AI model cooperate to produce behavior-aware, constraint-compliant schedules with improved computational efficiency and reliability.

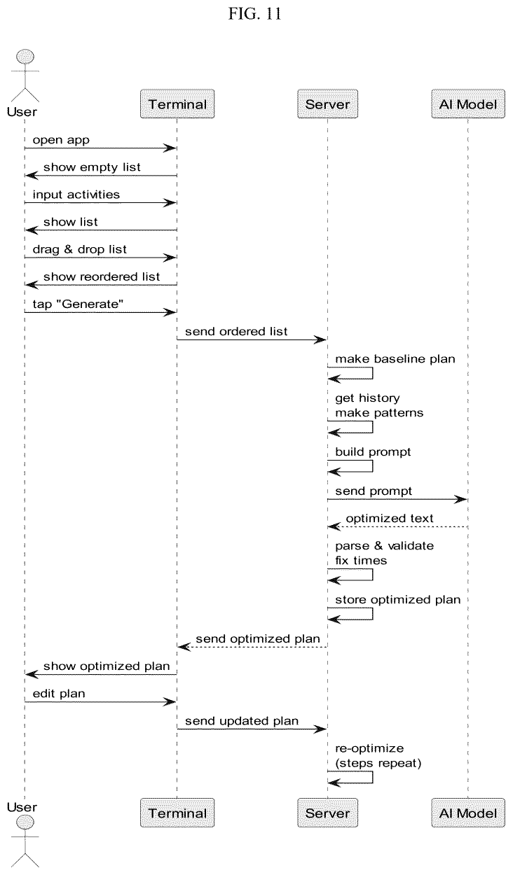

The following describes the processing flow using FIG. 11.

### Step 1

The user launches the scheduling application on the terminal.

The terminal receives, as input, a user action to start the application (for example, a tap on an icon) and configuration data stored locally.

The terminal initializes the graphical user interface, allocates an in-memory list structure for activities, and outputs an initial empty input screen with text fields, an empty list area, and control buttons.

### Step 2

The user inputs activity information or movement information as text data into the terminal.

The terminal receives, as input, character sequences entered into text boxes, such as “go to a café,” “watch a movie,” and “take a walk in the park.”

The terminal converts each text string into structured data by creating a record including at least a unique identifier, a title, an optional category, a default duration, and an order index equal to the current list length.

The terminal outputs an updated internal activity list and a corresponding visual list display showing each activity as a list item.

### Step 3

The user performs drag-and-drop operations on the list displayed by the terminal.

The terminal receives, as input, low-level events such as touch-down, drag-move, and touch-up (or mouse-down, mouse-move, mouse-up) associated with specific list items.

The terminal processes these events to compute new positions of the dragged items, updates the order index fields in the corresponding structured records, re-sorts the internal activity list according to the new indices, and outputs an updated ordered list structure and a re-rendered list display reflecting the user-defined order.

### Step 4

The user instructs the terminal to request a plan based on the current ordered list.

The terminal receives, as input, a user command such as a tap on a “Generate Plan” button and the current ordered activity list in memory.

The terminal serializes the ordered activity list into a request payload including user identifier, activity records with order information, and optional constraint parameters such as a preferred day and time window, and outputs a network message transmitted to the server via a communication interface.

### Step 5

The server receives the ordered activity list from the terminal.

The server receives, as input, the network message containing user identifier, activity records, and constraint parameters.

The server parses the payload, validates basic structure and types, normalizes text fields if needed, and stores the activity records in a database table or collection associated with the user.

The server outputs a persistent representation of the user's current ordered activity list and an internal data structure ready for scheduling.

### Step 6

The server generates a baseline plan using a deterministic scheduling algorithm.

The server receives, as input, the ordered activity list, the user's configured daily time range (for example, 09:00-21:00), and default or configured durations for each activity.

The server initializes a current time pointer at the start of the daily time range and, for each activity in order, uses a time information calculation library to compute a start time (next available slot within the allowed range) and an end time (start time plus duration), skipping over any blocked intervals derived from the user's existing schedule.

The server checks for overlaps and range violations; if any are detected at this stage, the server shifts times forward within the allowable window following fixed rules.

The server outputs a baseline plan as a set of records containing activity identifiers, computed start times, computed end times, and a baseline plan identifier, and stores this baseline plan in the database.

### Step 7

The server retrieves past execution history data for behavior pattern analysis.

The server receives, as input, the user identifier and, optionally, a time range for history retrieval.

The server queries the storage device for records of past baseline and optimized plans and execution logs, including actual start and end times, completion statuses, and user feedback flags.

The server aggregates this data by activity type or category, calculates statistics such as average stay duration and preferred start time ranges using numerical operations, and outputs behavior pattern information consisting of structured statistical summaries for each activity type.

### Step 8

The server generates a behavior pattern summary in natural language.

The server receives, as input, the structured behavior pattern information (for example, average cafe stay: 90 minutes; preferred walk start: after 17:00).

The server applies a template-based generation process: it maps numerical values to linguistic expressions (for example, “about 90 minutes”) and inserts them into predefined sentence templates.

The server outputs a behavior pattern summary text such as “The user usually spends about 90 minutes at cafe-type activities, starts movie-type activities between 13:00 and 15:00, and prefers outdoor walking-type activities after 17:00.”

### Step 9

The server constructs a prompt sentence for the generative AI model.

The server receives, as input, the ordered activity list, the baseline plan, the behavior pattern summary text, and constraint parameters such as the daily time window and a waiting-time reduction objective.

The server formats these inputs into a single prompt sentence or multi-line prompt, concatenating:
(1) a list of activities with their order,
(2) the baseline schedule with start and end times,
(3) the behavior pattern summary, and
(4) explicit constraints (order maintenance, non-overlap, allowable time range, and idle time minimization).

The server outputs a complete prompt sentence, for example:

“User-defined ordered activities: 1) go to a cafe, 2) watch a movie, 3) take a walk in the park.

Baseline schedule:
go to a cafe: 10:00-11:00
watch a movie: 13:00-15:00
take a walk in the park: 16:30-17:15

User behavior patterns: the user usually spends about 90 minutes at cafe-type activities, prefers movies in the early afternoon, prefers walks after 17:00, and dislikes long idle gaps between activities.

Constraints: respect the user-defined order strictly; keep all activities between 09:00 and 21:00; minimize idle time between consecutive activities; do not overlap activities.

Generate an optimized one-day plan that adjusts specific start times and end times for each activity. Output the result with each line formatted as ‘HH:MM-HH:MM: activity’.”

### Step 10

The server sends the prompt sentence to the generative AI model and receives an optimized schedule description.

The server receives, as input, the prompt sentence constructed in Step 9 and model configuration parameters (for example, temperature, maximum tokens).

The server transmits the prompt sentence to a generative AI model implemented as a transformer-based neural network through an application programming interface.

The generative AI model encodes the prompt into token embeddings, processes them through multiple attention layers, and decodes a sequence of output tokens representing adjusted times for each activity.

The server receives the generated text as output, such as lines of the form “10:30-12:00: go to a cafe,” and stores this raw AI output in memory for further processing.

### Step 11

The server parses the AI-generated text into structured optimized plan data.

The server receives, as input, the raw text output from the generative AI model.

The server applies pattern-matching rules or regular expressions to extract start times, end times, and activity labels from each line.

The server converts extracted time strings to internal time objects using the time information calculation library and maps each activity label back to an activity identifier in the originally ordered list.

The server outputs a preliminary optimized plan represented as a set of records containing activity identifiers, proposed optimized start times, and proposed optimized end times.

### Step 12

The server validates the optimized plan and applies deterministic time corrections if necessary.

The server receives, as input, the preliminary optimized plan, the user-defined order information, and constraint parameters (predetermined time range, non-overlap, time format).

The server checks that the sequence of activity identifiers in the optimized plan matches the ordered list; if not, the server reorders records to match the user-defined order.

The server verifies each time value against the required format (for example, HH:MM), confirms that all start and end times are within the daily time window, and checks for overlaps by comparing cumulative time intervals.

If the server detects minor violations (such as an overlap of a few minutes), the server runs a deterministic correction algorithm that shifts start times forward or compresses idle gaps according to fixed rules, while preserving order and constraints.

The server outputs a verified optimized plan that is guaranteed to match the user-defined order, respect all constraints, and be internally consistent.

### Step 13

The server stores the verified optimized plan in the storage device.

The server receives, as input, the verified optimized plan records and associated metadata such as a plan identifier, generation timestamp, and a flag indicating AI optimization.

The server writes these records into the database table or collection for plans, linking them to the corresponding user and baseline plan.

The server outputs a persistent, retrievable representation of the verified optimized plan and may send an acknowledgment to internal logging systems.

### Step 14

The server sends the verified optimized plan to the terminal.

The server receives, as input, a request from the terminal for the latest optimized plan or triggers a push in response to plan generation.

The server packages the optimized plan records into a response message that includes activity titles, start times, end times, and optional descriptive notes on the optimization.

The server outputs this message via the communication interface, delivering it to the terminal.

### Step 15

The terminal receives and displays the verified optimized plan for the user.

The terminal receives, as input, the response message containing the verified optimized plan.

The terminal parses the message, converts time strings to display-ready formats, and populates a schedule view, such as a timeline or a list with “HH:MM-HH:MM: activity” entries.

The terminal outputs a visual schedule display on the screen, allowing the user to see the AI-adjusted start and end times in the prescribed order.

### Step 16

The user reviews the optimized plan and optionally performs re-editing operations.

The terminal receives, as input, user interactions on the displayed schedule, such as changes in activity order, insertion of new activities, modification of priority or constraint fields, or marking of forbidden time periods.

The terminal updates the local activity and plan data structures according to these edits and outputs new ordered list information and updated constraints to the server in a re-optimization request.

### Step 17

The server performs iterative re-optimization based on updated user input.

The server receives, as input, the updated ordered list, modified constraints, and possibly revised behavior pattern information accumulated from additional history.

The server recalculates a new baseline plan if necessary, regenerates a behavior pattern summary, and constructs a new prompt sentence reflecting the updated state, again including explicit constraints.

The server sends the new prompt sentence to the generative AI model, receives a new generated schedule description, parses and validates the result as in Steps 10-12, and outputs an updated verified optimized plan for storage and delivery to the terminal.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional electronic planning systems and task management systems typically provide only static list management functions, in which a user manually enters activities or destinations and manually adjusts their order. In such systems, a processing device often treats a list merely as a sequence of display items, without performing sophisticated computation on list-order changes, without automatically generating time-aware execution plans, and without adapting plans based on real-time user progress. As a result, these systems impose a cognitive and operational burden on the user, who must repeatedly recalculate schedules, reorder tasks, and adjust times in response to delays or changing circumstances.

Furthermore, conventional systems that attempt to use machine learning or artificial intelligence often apply generic recommendation engines that are not tightly integrated with the underlying data structures and control logic of the planning engine. In many cases, a generative model is used only to output textual suggestions, while the core scheduling and routing computations remain disconnected from such suggestions. Consequently, these systems do not fully exploit user-specific execution histories, list-reordering behavior, or real-time progress updates as first-class computational inputs, and they cannot efficiently produce plans that both respect user preferences and optimize resource utilization.

In addition, existing systems typically lack a standardized mechanism for constructing and supplying prompt sentences to a generative model in a way that directly encodes the internal state of the planning engine, including ordered sets of items, change histories, and constraint information. Without such a mechanism, integration between planning logic and generative models tends to be ad hoc, brittle, and inefficient. It becomes difficult to reliably adjust execution priorities, compute recommended time windows, or dynamically update plans in response to feedback, using the generative model as a component of the overall computational pipeline.

From a computer-technology standpoint, there is a need for improved techniques for: (i) structuring user activity and destination information as ordered sets in memory resources; (ii) transforming drag-and-drop reordering operations into robust, transactionally consistent updates of position identifiers in storage resources; (iii) executing systematic computation processes to derive time-aware and resource-aware plan information; and (iv) programmatically generating and supplying prompt sentences to a generative information processing model so that the model's responses can be deterministically consumed by the planning engine. Absent such techniques, server-side processors cannot efficiently generate and maintain optimized, user-adaptive plans in a way that reduces server computation overhead, improves responsiveness, and enhances the technical performance of the overall planning system.

Accordingly, there is a demand for a computer-implemented planning system in which a processor manages ordered sets of planning elements, interprets user reordering operations, computes execution orders and times based on explicit optimization criteria, and cooperates with a generative information processing model via structured prompt sentences. Such a system should dynamically update plans based on progress information, thereby improving the internal operation of the planning engine, the utilization of storage and computation resources, and the overall efficiency and reliability of computer-based scheduling and delivery planning.

The specific processing by the specific processing unit 290 of the data processing device 12 in Application Example 1 is realized by the following means.

The present invention provides a server comprising a processor and at least one storage resource, the processor being configured to receive, from a terminal, activity information and destination information, store the activity information and the destination information as elements of an ordered set in the storage resource, and provide a user interface to the terminal so as to visually display the ordered set on the terminal; to receive, from the terminal, order information indicating a change of a relative positional relationship among the elements included in the ordered set, update ordinals or position identifiers associated with the elements of the ordered set based on the order information, and store an updated ordered set in the storage resource in a transactionally consistent manner; to execute computation processing to calculate plan information including an execution order and an execution time for the elements based on an order of the elements included in the updated ordered set and attribute information associated with the elements, the computation processing using utilization efficiency of at least one delivery resource or at least one movement resource as an evaluation index, and to generate the plan information as structured data and as a natural language expression that are transmittable to the terminal; to generate a prompt sentence based on the activity information, the destination information, the plan information, and execution history information of a user, to input the prompt sentence to a generative information processing model, and to generate an optimized plan reflecting a behavior tendency and a priority of the user by modifying or supplementing at least a part of the plan information based on a response acquired from the generative information processing model; and to receive, from the terminal, progress information indicating an execution status of each element included in the plan information, recalculate the plan information based on the progress information, and transmit updated plan information to the terminal so as to dynamically update a plan in accordance with an execution status of the user. This enables the server-side computer system to internally represent and maintain user activities as ordered data structures, to convert user interface operations into consistent updates of sequence metadata, to compute resource-aware and time-aware execution plans, and to tightly integrate generative-model outputs into the core scheduling logic, thereby improving the technical performance, adaptability, and efficiency of computer-implemented planning and delivery optimization.

The term “system” refers to a combination of at least one processing apparatus and at least one storage apparatus that cooperatively execute the functions described in the claims.

The term “processor” refers to a hardware computation unit, such as a central processing unit or a processing circuit, that executes machine-readable instructions to perform the operations described in the claims.

The term “storage resource” refers to a hardware storage apparatus, such as a memory device or a persistent storage device, that stores data structures including ordered sets, plan information, execution history information, and progress information.

The term “terminal” refers to an information processing apparatus operated by a user, such as a portable device or a fixed device, that is configured to transmit data to and receive data from the server and to present a user interface.

The term “activity information” refers to information representing an action, task, or operation that a user intends to perform.

The term “destination information” refers to information representing a place, location, or facility that a user intends to visit or that is associated with an activity.

The term “ordered set” refers to a data structure in which a plurality of elements are stored together with information indicating a relative order or sequence among the elements.

The term “element” refers to a unitary data item included in the ordered set, the unitary data item corresponding to at least one activity information item or destination information item.

The term “user interface” refers to a software-controlled presentation and input mechanism that permits the terminal to display data and receive user operations related to the ordered set and plan information.

The term “order information” refers to data indicating a change in a relative positional relationship among elements in the ordered set, the data being derived from user operations such as a reordering manipulation.

The term “relative positional relationship” refers to a relationship among elements in which the placement of each element is specified with respect to other elements in a sequence.

The term “ordinal” refers to a numerical or symbolic identifier representing a position of an element within the ordered set.

The term “position identifier” refers to data indicating an element's placement in the ordered set, including but not limited to an index value, rank value, or sequence number.

The term “updated ordered set” refers to the ordered set after modification of ordinals or position identifiers based on received order information.

The term “transactionally consistent manner” refers to a method of updating data in which a set of related operations is executed as an atomic unit such that either all of the operations are completed or none of them are committed.

The term “attribute information” refers to information associated with an element, including at least one of type information, duration information, location information, or constraint information.

The term “computation processing” refers to one or more machine-executed operations, including calculation, comparison, sorting, or optimization, performed by the processor based on input data.

The term “plan information” refers to data that specifies at least an execution order and an execution time for elements, and optionally includes additional parameters used for scheduling or routing.

The term “execution order” refers to an arrangement specifying the sequence in which elements are to be processed or carried out.

The term “execution time” refers to a scheduled time or time period associated with an element, including at least one of a start time, end time, or recommended time window.

The term “delivery resource” refers to a physical or logical resource used for transporting goods, items, or services, including but not limited to vehicles, delivery personnel, or delivery systems.

The term “movement resource” refers to a physical or logical resource used for moving a user or object between locations, including but not limited to transport means or mobility services.

The term “evaluation index” refers to a quantitative or qualitative metric used by the processor to assess and compare alternative plans, including but not limited to utilization efficiency, total time, or cost.

The term “structured data” refers to data formatted according to a defined schema or data model, such as key-value structures, tables, or markup structures, that is machine-interpretable.

The term “natural language expression” refers to text or speech content composed in a human language so that it is understandable by a human user.

The term “prompt sentence” refers to a data string or collection of text that encodes a request, instruction, or context, and that is supplied as input to a generative information processing model.

The term “generative information processing model” refers to a trained computational model that, upon receiving input data such as a prompt sentence, generates output data including at least natural language text or structured suggestions.

The term “execution history information” refers to data indicating past execution results for elements, including completion times, statuses, and past plan versions for a user.

The term “response” refers to output data produced by the generative information processing model in reaction to a supplied prompt sentence.

The term “optimized plan” refers to plan information that has been modified or generated so as to improve at least one evaluation index, such as resource utilization efficiency or time efficiency, under given constraints.

The term “behavior tendency” refers to a pattern in user actions over time, including typical ordering, timing, or selection behaviors.

The term “priority” refers to a relative level of importance, preference, or urgency assigned to an element for use in scheduling or optimization.

The term “progress information” refers to data indicating a current execution status of each element, including at least one of a completed state, an in-progress state, or a delayed state.

The term “execution status” refers to a condition or phase of processing for an element, including not-yet-started, executing, completed, or canceled.

The term “time allocation problem” refers to a computational problem in which time intervals or time points are assigned to elements under given constraints.

The term “required time information” refers to data indicating an expected or nominal duration associated with executing an element.

The term “location information” refers to data specifying a position or place associated with an element, including but not limited to address data, coordinates, or zone identifiers.

The term “resource constraint information” refers to data describing limitations or capacities of resources that affect scheduling or routing, including time limits, availability windows, or quantity limits.

The term “recommended time period” refers to a time interval suggested for starting or completing an element in order to improve an evaluation index.

The term “start time candidate” refers to one or more proposed start times for an element, obtained as part of the output of the generative information processing model.

The term “time resource” refers to a temporal capacity available to the user, such as a daily schedule, free time windows, or working hours.

In one embodiment, a server cooperates with at least one terminal to implement the claimed system. The server includes a processor, a main memory, a non-volatile storage device, a network interface, and an operating system. The server executes an application program that includes a planning module, a data management module, an optimization module, and a generative-model interface module. The terminal includes a processor, a display, an input device such as a touch panel, a memory, and a communication module, and executes a client application or a web browser that presents a user interface and communicates with the server over a communication network.

The server uses the processor to execute a web application framework, such as a general server-side framework implemented in a high-level language, and to implement application programming interfaces that exchange data with the terminal over a transport protocol. The server uses a database management system, such as a relational database system, as the storage resource for ordered sets, user profiles, execution history information, and plan information. The server also uses a generative AI model that is deployed as a separate service or as a library on the server.

The terminal displays, on the display, a graphical user interface implemented, for example, using markup code and script code executed in a browser, or using a native mobile user interface toolkit. The terminal presents input fields for activity information and destination information and list components whose items can be reordered via drag-and-drop operations. The user inputs activity information, such as “have lunch,” “study,” or “buy groceries,” and destination information, such as “restaurant,” “library,” or “store,” by typing characters or selecting items from predefined lists. The terminal converts the user's operations into structured data, such as textual fields, identifiers, and order indices, and transmits the structured data to the server via the communication module.

The server receives the activity information and destination information from the terminal and stores the information as elements of an ordered set in the database. The server represents the ordered set using a data structure that includes, for each element, an element identifier, a user identifier, an ordinal or position identifier, and attribute information such as type, estimated duration, associated location, and resource constraints. The server uses indexing mechanisms provided by the database system to efficiently retrieve and update elements by their identifiers and positions.

The server performs data processing to maintain the ordered set when the terminal transmits order information indicating a change of relative positions among the elements. The server updates ordinals or position identifiers in a transactionally consistent manner by executing a set of database update operations within a transaction, so that partial failures do not leave the ordered set in an inconsistent state. The server employs a rule in which the processor renumbers affected elements by assigning contiguous integers according to the new order, thereby avoiding gaps and reducing the amount of index data required. This renumbering improves the efficiency of subsequent sorting operations and range queries on the ordered set.

The server uses the optimization module to execute computational operations that generate plan information. The optimization module receives the updated ordered set and associated attribute information as input, and performs operations such as sorting, graph-based path evaluation, and time-window analysis. In one embodiment, the server models locations as nodes in a graph and travel relations as weighted edges, where the weights represent travel times or costs. The server calculates, for each element, an execution order and execution time based not only on the user-specified order but also on constraints such as opening hours, preparation times, and travel durations. The server may use a heuristic search algorithm or a mixed-integer optimization method to minimize a total cost function that combines total travel time, lateness penalties, and user preference weights. By optimizing this cost function, the server reduces the number of iterations and the volume of search space compared to naive brute-force methods, thereby improving processing speed and reducing resource consumption.

The server generates plan information both as structured data and as a natural language expression. The server formats the structured data as a set of records including element identifiers, scheduled start times, end times, and status flags. The server also creates a natural language explanation of the plan, for example: “First, arrive at the sushi restaurant at 18:30, then go to the cafe at 19:15, and finally receive the pizza delivery at 20:00.” The terminal receives this plan information and displays it in a list or timeline format so that the user can easily understand and follow the plan.

The server uses the generative-model interface module to integrate a generative AI model into the planning process. The server constructs a prompt sentence that encodes the internal state of the planning engine. For example, the server generates a prompt sentence such as: “Given the following user activities and destinations with estimated durations and current ordering: 1) sushi restaurant, 45 minutes, 2) cafe, 60 minutes, 3) pizza delivery, 30 minutes, and the user's past tendency to prefer earlier dinners and shorter gaps between meals, suggest adjustments to the schedule and priorities to optimize time efficiency and user satisfaction.”

The server supplies such prompt sentences to a generative AI model that is implemented as a neural network. In one embodiment, the generative AI model is a transformer-based language model that has multiple attention layers, feed-forward layers, and learned embeddings for tokens. The server configures the model with a predetermined number of layers, attention heads, and hidden units, and uses a pretraining phase followed by fine-tuning with domain-specific data. The server generates features for the prompt by encoding activity types, durations, and user-specific statistics into textual tokens and structured annotations. The server uses these features to enable the model to infer relationships between activities, preferences, and schedule feasibility that are not captured by simple rule-based logic.

The server uses a loss function, such as a cross-entropy loss over target textual outputs representing desired scheduling modifications, during the training or fine-tuning of the generative AI model. The server updates the model's weights using a gradient-based optimization algorithm, such as stochastic gradient descent with adaptive learning rate control. The server may also apply data augmentation techniques, such as simulating different user histories and list permutations, to improve the robustness of the model and reduce overfitting. By employing these techniques, the server obtains a model that can generate consistent and context-aware responses to prompt sentences describing planning scenarios.

The server receives responses from the generative AI model and parses the responses to extract scheduling suggestions, priority adjustments, and recommended time windows. The server does not rely on the generative model to directly produce final plans; instead, the server uses the responses as advisory input to the optimization module. The server maps natural language output into structured control parameters, such as increased weights for certain elements, modified earliest-start times, or merged time windows. The server then runs the optimization computations again using these updated parameters. This division of roles ensures that the generative AI model supports but does not replace deterministic optimization algorithms, and that the final plan remains internally consistent with the data structures maintained by the server.

The server generates another prompt sentence to learn user patterns over time. For example, the server may generate a prompt sentence such as:

“Analyze the following history of completed plans and list reordering operations for a user and summarize the user's behavior pattern and preferences regarding timing and ordering of meals and visits.”

The server then uses the model's summary to update long-term user profiles stored in the database, including typical preferred time ranges, usual ordering of meal types, and sensitivity to waiting times. The server encodes these profiles as numerical parameters and categorical tags that are directly used by the optimization module. This configuration allows the server to gradually improve prediction accuracy and schedule quality without requiring handcrafted rules for each user.

The server monitors progress information sent from the terminal. The user interacts with the terminal to mark items as completed or delayed. The terminal transmits, for each element, a status indicator and actual timestamps. The server records this progress information in the database and uses it for real-time replanning. When the server detects a significant deviation from the original schedule, the server recalculates plan information for remaining elements. The server can also generate a new prompt sentence to explain the current state and ask the generative AI model for suggested adjustments, for example:

“Given that the user completed the sushi restaurant visit 20 minutes later than scheduled and has not yet visited the cafe, recalculate a realistic schedule for the remaining activities, prioritizing minimal lateness and avoiding arrival after closing times.”

The server then applies the recommendations from the generative AI model to refine parameters and reruns the optimization algorithm. This feedback loop reduces cumulative error and maintains a feasible plan even under changing conditions.

The server thus improves computer technology by introducing specific data structures, control flows, and model-integration techniques that reduce processing load and communication volume. For example, by representing user plans as ordered sets with compact ordinal fields and by transmitting only changed positions rather than complete lists, the server reduces network traffic and database write volume. By delegating pattern recognition and long-term preference inference to the generative AI model and keeping deterministic optimization for sequence and timing computation, the server achieves higher scheduling accuracy with fewer optimization iterations. This arrangement shortens processing time and reduces the number of calls to external services such as mapping or routing services.

The server further improves internal data management by structuring input data and model output around well-defined schemas and preprocessed features. The server converts raw text activities into normalized tokens and attaches metadata such as standard categories and estimated durations. This normalization allows the optimization module to operate with consistent units and constraints, which improves the convergence and stability of optimization routines. Additionally, the server uses caching strategies for repeated queries to the generative AI model and for frequently accessed plan segments, thereby reducing latency and redundant computations.

The terminal benefits from the server's computational improvements by receiving more accurate and stable plans with fewer updates. The user, in turn, experiences a smoother interaction because the terminal does not need to request complete recalculation for every minor change; instead, the terminal transmits incremental progress updates that the server processes efficiently. This structure is different from manual human planning or simple automation of human tasks because the server uses machine-readable formalization of activities, mathematical optimization, and model-based parameter adjustment that cannot be readily performed by human planners in real time.

In another embodiment, the server uses alternative algorithmic structures for the optimization module, such as dynamic programming or constraint programming, and different generative AI model architectures, such as recurrent neural networks or hybrid encoder-decoder models. The server can also employ different feature extraction strategies, such as embedding locations into a low-dimensional space based on historical travel times or clustering users based on behavior patterns. These variations still follow the fundamental concept of encoding internal planning states into prompt sentences, obtaining nuanced suggestions from the generative AI model, and systematically feeding those suggestions into deterministic optimization processes.

In yet another embodiment, the server is configured to work with multiple terminals associated with a single user or with a group of users. The server aggregates execution history information across devices and uses the same principles of ordered-set management and prompt-based model integration. The server may weight different devices or users differently, depending on roles or permissions, when generating plans. This multi-device embodiment demonstrates that the internal data structures and algorithms scale across diverse usage contexts, and that the technical effects of improved scheduling accuracy, reduced computation time, and better resource utilization are maintained under higher loads.

By implementing these embodiments, the server, the terminal, and the user cooperate in a way that enhances the technical functioning of the computing system itself. The system converts complex human planning patterns into structured data and optimized schedules using specific algorithms and a tightly integrated generative AI model. As a result, the system achieves improved processing speed, higher plan accuracy, reduced communication overhead, and better management of computational and time resources, thereby going beyond mere automation of mental steps or business practices and providing concrete improvements in computer technology.

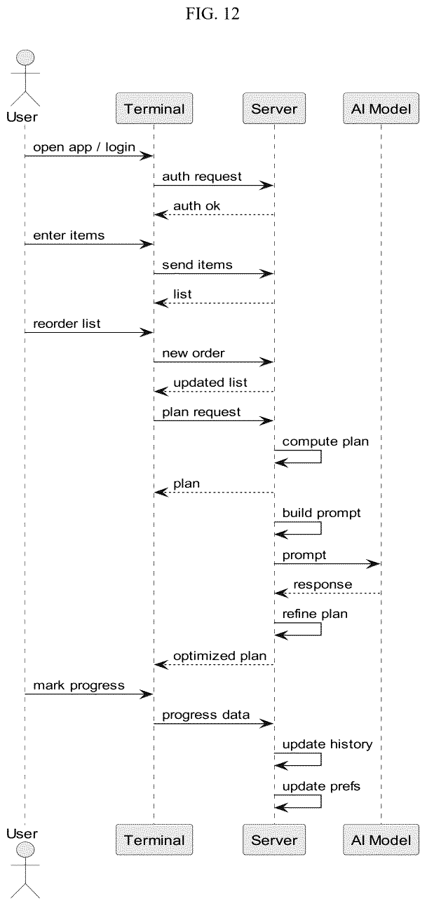

The following describes the processing flow using FIG. 12.

### Step 1

The terminal displays an initial planning screen to the user and transmits basic user context to the server.

The user operates the terminal to open the planning application and optionally logs in by entering authentication information.

The terminal sends, as input to the server, user identification information and session information.

The server receives this input and performs a data operation that verifies the user identification against stored records, generates a session token, and initializes an in-memory context structure for the user.

The server outputs an initialization response containing the session token, user profile parameters, and default planning settings, which the terminal stores for subsequent requests.

### Step 2

The terminal collects activity information and destination information from the user and transmits these to the server.

The user enters, as input, textual descriptions of activities and destinations (for example, “sushi restaurant,” “cafe,” “pizza delivery”) and may also specify optional parameters such as desired date, approximate duration, or preferred time range.

The terminal converts this input into structured data by attaching identifiers, normalizing text, and grouping related fields, and outputs a request message containing a list of elements and their attributes.

The server receives this request as input and performs data processing that includes parsing the structured data, checking data types and required fields, and assigning temporary element identifiers and initial position identifiers.

The server outputs an ordered set representation in which each element has an identifier, an initial ordinal, and attribute information, and stores this ordered set in a storage resource.

### Step 3

The terminal displays the ordered set to the user and enables reordering operations through the user interface.

The user provides input by dragging and dropping list items to new positions on the display, thereby changing the visual order of activities and destinations.

The terminal detects these operations as input events, recalculates position indices for affected elements, and outputs updated order information consisting of element identifiers and corresponding new ordinals.

The server receives the updated order information, interprets it as input specifying new relative positions, and executes data operations to update the ordered set: the server renumbers and normalizes ordinals so that they form a contiguous sequence, and updates the records in the storage resource in a transactionally consistent manner.

The server outputs an updated ordered set with consistent position identifiers, which becomes the basis for subsequent optimization.

### Step 4

The server computes initial plan information based on the updated ordered set and attribute information.

The server uses, as input, the updated ordered set, estimated durations for each element, and any location information such as addresses or coordinates.

The server performs data operations that include constructing a graph model of locations, calculating travel times using stored reference data or external service responses, and applying an optimization algorithm (for example, a heuristic or constraint-based procedure) to determine an execution order and execution times that respect the user-defined order and constraints.

The server outputs plan information that includes, for each element, a scheduled start time, an expected end time, and additional metadata such as resource assignment or slack time, and stores this plan information in the storage resource while simultaneously transmitting it to the terminal.

### Step 5

The terminal presents the plan information to the user in both structured and natural language forms.

The terminal receives, as input, the structured plan data and any accompanying textual explanation from the server.

The terminal performs display-related data processing to map each element and its scheduled time to visual components such as list rows or timeline segments, and formats the natural language explanation for human readability.

The terminal outputs a composite user interface in which the user can view the ordered activities, their execution times, and explanations of the schedule.

### Step 6

The server generates a prompt sentence for a generative AI model to refine the plan.

The server uses, as input, the ordered set, the current plan information, and execution history information associated with the user (for example, past completion times, typical delays, and previous reordering patterns).

The server performs a data operation that transforms these internal structures into a linearized textual representation, concatenating activity descriptions, durations, time windows, and history-derived statistics into a coherent prompt sentence.

For example, the server may output a prompt sentence such as:

“Given the following ordered activities and their estimated durations and the user's past tendency to prefer earlier meals and minimal waiting time, propose adjustments to priorities and time windows: 1) sushi restaurant, 45 minutes, 2) cafe, 60 minutes, 3) pizza delivery, 30 minutes.”

This prompt sentence is the output of this step and is passed as input to the generative AI model.

### Step 7

The server obtains a response from the generative AI model and converts that response into optimization parameters.

The server sends, as input to the generative AI model, the prompt sentence generated in the previous step, together with model configuration parameters such as maximum output length and decoding temperature.

The generative AI model outputs a natural language response that may contain recommended priority changes, adjusted time windows, or comments about potential conflicts.

The server takes this response as input and performs data processing that includes parsing the text, extracting structured values (such as suggested earlier start times, markers of high priority, or recommended grouping of activities), and mapping them to numerical weights, revised constraints, or flags in the optimization module.

The server outputs updated optimization parameters and stores them together with the plan context.

### Step 8

The server recalculates the plan using the updated optimization parameters derived from the generative AI model.

The server uses, as input, the updated ordered set, the previous plan information, and the adjusted weights, time-window constraints, and priority values obtained from the parsing of the generative AI model's response.

The server performs a sequence of data operations that may include re-running a route selection algorithm, recomputing start times to avoid conflicts, minimizing a cost function that reflects both resource efficiency and user preferences, and checking constraint satisfaction.

The server outputs an optimized plan in which execution order and execution times are refined, and generates a new natural language explanation summarizing the changes, then transmits this updated plan and explanation to the terminal.

### Step 9

The terminal displays the optimized plan and allows the user to confirm or further adjust it.

The terminal receives, as input, the optimized plan and new explanation from the server.

The terminal performs UI update operations that compare the previous plan and the optimized plan, highlight modified times or priorities, and optionally show annotations explaining the changes.

The terminal outputs an interactive display in which the user can review the optimized schedule and either accept it or perform additional reordering, which, if performed, becomes new input for Step 3.

### Step 10

The user follows the plan and the terminal collects progress information for transmission to the server.

The user operates the terminal to mark elements as started, completed, or delayed, and may enter actual start and completion times.

The terminal takes these user operations as input, converts them into structured progress information including timestamps and status codes, and outputs update messages to the server.

The server receives this progress information and performs data processing that updates execution history records, recalculates remaining available time, and evaluates deviations between scheduled and actual times.

The server outputs updated history data and may also produce internal triggers to invoke further optimization or generative-model-based refinement.

### Step 11

The server optionally generates a new prompt sentence to analyze user behavior and update long-term preference models.

The server uses, as input, accumulated execution history information, records of list reordering operations, and previous plan adjustments.

The server performs a data operation that summarizes these records into a descriptive text, including typical delay patterns, frequently reordered item types, and recurring time preferences, and embeds this summary into a prompt sentence.

For example, the server may output a prompt sentence such as:

“Based on the following series of plans and actual completion times, describe the user's usual preferred time for dinner and tolerance for delays, and suggest updated preference parameters.”

The server sends this prompt sentence to the generative AI model and uses the model's response as input to adjust stored user profile parameters, thereby outputting refined preference data that will influence future computations in Step 4 and Step 8.

### Step 12

The server updates internal models and data structures to improve future processing efficiency and accuracy.

The server uses, as input, the refined preference parameters obtained from the generative AI model and the updated history data aggregated from multiple planning sessions.

The server performs data operations that include recomputing default duration estimates, adjusting initial weight values used in optimization for certain activity types, and configuring caching strategies for frequently used patterns or locations.

The server outputs updated configuration records and cached structures that are stored in the storage resource and used in subsequent planning cycles.

By doing so, the server reduces the amount of computation required for future plan creation and improves the quality of initial plans before any user-specific refinement or generative-model interaction is performed.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional electronic list management and scheduling systems typically rely on static user interfaces and manually defined rules to determine the display order of items. In many implementations, a processor merely presents user-entered activities in chronological or priority-based order and allows the user to rearrange items via drag-and-drop operations. Although some systems may generate a plan based on the rearranged order, the underlying computing mechanisms do not effectively leverage accumulated behavioral data, such as action history, usage frequency, and time-of-day patterns, to adaptively optimize the ordering logic over time. As a result, the system behavior remains largely reactive to explicit user input rather than proactively learning from historical context.

This conventional architecture leads to several technical problems in computer operation. First, the processor repeatedly executes simplistic sorting or rule-based algorithms that do not improve with additional data, thereby failing to exploit available processing resources and storage resources to enhance prediction accuracy or ranking quality. Second, the system typically treats a generative artificial intelligence model, if used at all, as a mere text generator rather than as a component integrated into the control flow for improving machine-learned models or ranking strategies. Consequently, the computing device is not configured to automatically refine feature sets, learning conditions, or scheduling rules based on feedback derived from the generative artificial intelligence model, and the overall system remains limited in adaptability and computational efficiency.

Furthermore, in many existing systems, explanation of recommendations or optimized orders is either not provided or is generated by simple template logic on the client side. The lack of a coordinated mechanism in which a server-side processor (i) aggregates behavioral logs, (ii) trains a prediction model for suitability scoring, (iii) dynamically reorders list items based on the model, and (iv) queries a generative artificial intelligence model with structured prompt sentences to obtain improvement policies and explanatory content, results in suboptimal use of computational resources and reduces user trust in the automated behavior of the system. In particular, the absence of a feedback loop between the predictive model and the generative artificial intelligence model prevents the system from evolving its internal ranking logic in response to actual user behavior.

Accordingly, there is a need for a computer-implemented technique that improves the functioning of the server by: (i) systematically collecting and aggregating behavior history, utilization frequency, and time zone information; (ii) executing machine learning processing to construct a prediction model that outputs suitability evaluation values for list elements; (iii) automatically adjusting list order on the basis of such values; and (iv) generating and submitting structured prompt sentences to a generative artificial intelligence model to obtain optimization strategies and explanatory information. By tightly integrating these processes at the server side, the invention aims to improve the technical performance of the system, including more accurate ranking, more efficient use of processing resources through informed model updates, and enhanced interpretability and usability through machine-generated explanations.

The specific processing by the specific processing unit 290 of the data processing device 12 in Example 2 is realized by the following means.

The present invention provides a server comprising a processor configured to provide, to a user terminal, a user interface for displaying in a list format activity information input by a user, to acquire behavior history information, utilization frequency information, and time zone information associated with elements of the list from the user terminal and store the information in a storage device, to execute statistical processing on the stored information to calculate behavior tendency information of the user and to generate feature information based on the behavior tendency information and importance information assigned by the user, to perform machine learning processing using the feature information and execution state information to construct prediction model information for outputting suitability evaluation values for the elements in the list, to calculate the suitability evaluation values for the elements based on the prediction model information and current date and time information and automatically adjust an order of the elements in the list according to the suitability evaluation values, to transmit updated list information based on the adjusted order to the user terminal, to generate a prompt sentence including summary information related to the behavior tendency information, the utilization frequency information, and the time zone information and instruction content for optimizing the order of the elements in the list, to input the prompt sentence to a generative artificial intelligence model and acquire response information including an improvement policy or explanatory information regarding action plan information or the adjusted order, and to correct at least one of the action plan information and an order adjustment process based on the response information or output the response information to the user. This enables the server to improve computer functionality by learning from accumulated behavioral data to construct and update a prediction model for ranking list elements, by dynamically reordering the list in response to suitability evaluation values computed at runtime, and by leveraging a generative artificial intelligence model through structured prompt sentences to refine machine learning conditions and generate explanations, thereby enhancing ranking accuracy, adaptive behavior, resource utilization, and transparency of the automated planning process.

The term “activity information” refers to information representing actions, tasks, or visits to places that a user plans to perform or has performed, including at least a title of the activity and optionally additional attributes such as a description, a due date, or a priority level.

The term “list” refers to a structured collection of one or more elements representing activity information, arranged in an order that can be displayed on a user interface and modified by a user or by an automatic reordering process.

The term “element” refers to an individual item included in a list, the element being associated with activity information and other related attributes such as identifiers, status, and priority.

The term “user interface” refers to a display and input environment provided by hardware and software components of an information processing device or user terminal, through which a user can view, select, and manipulate activity information and list elements.

The term “information processing device” refers to an electronic apparatus, including at least one processor and memory, that executes programs to process data and provide functions such as user interfaces, communication, and storage.

The term “user terminal” refers to a client-side electronic device operated by a user, such as a smartphone, tablet, or personal computer, that communicates with a server to send and receive information including activity information, behavior history information, and updated list information.

The term “behavior history information” refers to data indicating past actions of a user related to list elements, including at least records of operations such as completing, editing, skipping, or viewing elements, with associated timestamps and optionally contextual attributes such as location.

The term “utilization frequency information” refers to information representing how often a particular element or activity is used, executed, or interacted with by a user over one or more time periods, and may include counts, rates, or aggregated statistics.

The term “time zone information” refers to information indicating temporal attributes associated with user behavior or execution of list elements, including at least dates, times of day, days of week, and classifications such as morning, afternoon, evening, or weekend.

The term “storage device” refers to a hardware resource for storing digital data, such as a memory, a magnetic disk, a solid-state drive, or a database system, configured to hold behavior history information, utilization frequency information, time zone information, and model-related data.

The term “statistical processing” refers to computational operations that analyze stored data to derive aggregated, summarized, or transformed values, such as counts, averages, distributions, and trends, used to characterize user behavior or usage patterns.

The term “behavior tendency information” refers to information derived from behavior history information through statistical processing that characterizes patterns in a user's actions, including preferred times for performing certain activities, frequently used elements, and recurring habits.

The term “importance information” refers to information indicating a relative priority or weight assigned to an element or activity, which may be explicitly specified by a user or implicitly derived from usage patterns.

The term “feature information” refers to a set of numerical or categorical variables generated from behavior history information, utilization frequency information, time zone information, behavior tendency information, importance information, or other attributes, and used as input to machine learning processing.

The term “execution state information” refers to information representing whether and how an element or activity has been executed, including at least a completion status, a completion time, or other indicators of actual performance.

The term “machine learning processing” refers to a computational procedure in which a model is trained using feature information and execution state information so that the model learns patterns or relationships and can make predictions or inferences for new data.

The term “prediction model information” refers to data and parameters defining a trained machine learning model that, when executed by a processor, accepts feature information as input and outputs one or more prediction values, such as suitability evaluation values.

The term “suitability evaluation value” refers to a numerical or categorical indicator output by the prediction model that represents an estimated degree of appropriateness, relevance, or priority of an element under a given context, such as a particular time or situation.

The term “order adjustment process” refers to a computational procedure that changes the order of elements in a list based on criteria, including suitability evaluation values, in order to generate an updated list that is optimized for a given context.

The term “updated list information” refers to information representing a list whose element order has been modified by the order adjustment process, including identifiers and attributes of the elements in their new positions.

The term “action plan information” refers to information representing a structured schedule or arrangement of one or more activities or elements over time, generated based on the order of elements in a list and optionally on additional constraints or preferences.

The term “prompt sentence” refers to a structured text string generated by the server that includes at least summary information and instruction content, and is provided as input to a generative artificial intelligence model to request a response related to optimization or explanation.

The term “summary information” refers to compact, processed representations of underlying data, such as behavior tendency information, utilization frequency information, and time zone information, formatted for inclusion in a prompt sentence.

The term “instruction content” refers to textual directives or questions included in a prompt sentence that specify the type of response requested from a generative artificial intelligence model, such as optimization strategies or explanatory descriptions.

The term “generative artificial intelligence model” refers to a software-implemented model, such as a large language model, that receives a prompt sentence as input and generates text or other data as output based on learned patterns from training data.

The term “response information” refers to information output by a generative artificial intelligence model in response to a prompt sentence, including at least improvement policies, suggestions, explanations, or other guidance related to action plan information or list ordering.

The term “improvement policy” refers to guidance or recommendations contained in response information from a generative artificial intelligence model, indicating modifications or enhancements to be applied to action plan information, prediction models, feature information, or order adjustment processes.

The term “explanatory information” refers to information generated by a generative artificial intelligence model that explains reasons or rationale for a given action plan, list order, or recommendation, presented in a human-understandable form.

The term “schedule information” refers to information indicating planned or existing time allocations of a user, including appointments, time slots reserved for specific activities, and calendar-related data.

The term “candidate time zone” refers to a suggested time period, such as a specific hour range or time-of-day segment, proposed as suitable for execution of a particular element or activity, typically derived from behavior patterns and schedule information.

The term “server” refers to an electronic computing apparatus, including at least one processor and one or more storage devices, configured to communicate with one or more user terminals over a network and to execute processes including data collection, machine learning, list reordering, and interaction with a generative artificial intelligence model.

In one embodiment, a server, a plurality of terminals, and a communication network cooperatively implement the claimed system. The server includes at least one processor, a main memory, a non-volatile storage device such as a magnetic disk or solid-state drive, and a network interface. The terminals each include at least one processor, a memory, a display device, an input device such as a touchscreen, and a wireless or wired communication module. The server executes programs stored in the non-volatile storage device to perform data collection, machine learning, list reordering, and interaction with a generative AI model, while the terminals execute client-side programs to provide user interfaces and send and receive data.

The terminal provides a user interface that allows a user to input activity information. The terminal displays a list, for example a to-do list or schedule list, in which each element corresponds to one item of activity information. The terminal stores locally, in a structured data format such as a table or key-value map, element identifiers, titles, optional descriptions, user-assigned priority values, and status flags such as “pending” or “completed.” The terminal renders the list using a graphical user interface framework, for example a mobile UI library, and accepts user operations such as tapping, long-pressing, and drag-and-drop. When the user changes the order of elements, the terminal updates a position index value associated with each element and transmits the updated list structure to the server via an HTTPS connection.

The server receives list data and behavior history information from the terminals through a network interface. The server parses incoming requests encoded in a structured message format and stores the extracted data in a database system, for example a relational database. The server maintains tables such as a user table, a list element table, and a behavior log table. The behavior log table stores, as records, user identifiers, element identifiers, action types (e.g., element creation, completion, editing, skipping, display), timestamps normalized to a unified time standard, and optional contextual attributes such as coarse-grained location and device type. The server also stores aggregate usage statistics in additional tables or materialized views to reduce query time.

The server executes data processing programs using a data analysis library such as a numerical computation library and a tabular data manipulation library. The server loads relevant records from the database into memory as structured arrays or data frames. The server applies data cleaning operations, including removal of records with invalid identifiers, normalization of timestamps into date, time-of-day, and day-of-week components, and mapping of raw action codes into standardized categories. The server generates time slot labels such as “morning,” “afternoon,” “evening,” and “night” by applying deterministic rules to the time-of-day field.

The server aggregates behavior history information by grouping records according to user identifier, element identifier, and temporal attributes. The server computes, for each element, overall completion counts, recent completion counts within predetermined time windows, completion counts per day-of-week, and completion counts per time slot. The server also computes recency-weighted scores by applying a weighting function that assigns larger weights to more recent actions. The server writes the resulting aggregate statistics to additional data structures in memory and, optionally, to persistent storage for reuse.

The server constructs feature information suitable for machine learning processing. The server represents each (user, element, context) combination as a feature vector. The context includes at least a current day-of-week, a current time slot, and, optionally, a current location category. The server maps categorical variables, such as day-of-week, time slot, and action type, to one-hot encoded binary vectors. The server normalizes numeric variables, such as completion counts and recency-weighted scores, using scaling methods such as min-max normalization or standardization. The server concatenates all feature values into fixed-length vectors that can be processed efficiently by machine learning algorithms.

In one embodiment, the server uses a decision-ensemble model such as a random forest or gradient-boosted decision tree as the prediction model. The server divides collected samples into training data and validation data. The server applies a supervised learning algorithm, in which the target label is either a binary execution indicator (indicating whether the user executed the element in a similar past context) or a numerical suitability score derived from execution frequency and recency. The server minimizes a loss function, such as log loss for classification or mean squared error for regression, by adjusting parameters of the model during training. The server uses cross-validation and hyperparameter search, such as grid search or randomized search, to identify model configurations that provide improved accuracy and stability.

In another embodiment, the server uses a neural network model to generate suitability evaluation values. The server constructs a feed-forward neural network with an input layer corresponding to the feature vector dimensions, one or more hidden layers with nonlinear activation functions such as rectified linear units, and an output layer that produces a scalar suitability score or a probability. The server initializes the weights and biases of the network, and uses an optimization algorithm such as stochastic gradient descent or Adam to update these parameters. The server computes gradients of a loss function, such as binary cross-entropy or mean squared error, with respect to the model parameters by backpropagation, and applies iterative updates based on mini-batches of training data. The server optionally applies regularization techniques, such as dropout or weight decay, to reduce overfitting.

The server stores trained prediction model information, including model parameters, feature normalization parameters, and feature index mappings, in the non-volatile storage device. By doing so, the server can load the model and associated configuration efficiently at runtime. The server maintains version identifiers for models so that different users or user groups can be associated with different model versions, and so that rollback to a previous model is possible if performance declines.

The server uses the stored prediction model information to calculate suitability evaluation values for elements currently in a list. When a terminal requests an updated list, the server determines the current context, including at least the current date and time, and optionally a current coarse-grained location and device type. The server retrieves the relevant aggregate statistics and user-specific configuration from the database or an in-memory cache. The server generates feature vectors for each list element based on the current context and the stored statistical data. The server applies the prediction model to compute suitability evaluation values, such as probabilities that the user will execute each element in the near future. The server then orders the elements according to these values and constructs updated list information.

The server transmits the updated list information to the terminal. The terminal receives the new element order and associated metadata, such as suitability scores and context labels, and renders the list in the updated order on the display. The user can visually confirm that items predicted to be highly relevant at the current time or context are presented at higher positions. If the user interacts with the list, for example by completing or ignoring recommended items, the terminal logs such interactions and sends them back to the server as new behavior history information, which the server will use in future training cycles.

The server further generates prompt sentences for use with a generative AI model. The server constructs a text string that includes summary information representing behavior tendency information, utilization frequency information, and time zone information for the user, together with explicit instructions requesting optimization strategies or explanations. For example, the server can generate a prompt sentence such as:

“Based on the following user behavior summary: the user completes ‘Go to the library’ mostly on Saturday afternoons and rarely on weekdays, and the user frequently completes ‘Grocery shopping’ on weekday evenings, propose a method to optimize the order of the user's task list for different days and times, and explain the reasoning in plain language.”

In another example, the server can generate a prompt sentence such as:

“Explain to the user why the system recommends placing ‘Go to the library’ at the top of the list on Saturday afternoon, given that historical logs show that the user usually completes this activity between 13:00 and 17:00 on Saturdays and rarely at other times.”

The server transmits the prompt sentence to a generative AI model hosted by an external computing system. The generative AI model is, for example, a large language model implemented as a multi-layer neural network with an attention mechanism. The server receives response information, which may include improvement policies such as suggestions for additional features, refined weighting of recency versus frequency, or natural-language explanations suitable for display to the user. The server parses the response information and either incorporates the proposed improvement policies into subsequent configurations of machine learning processing or stores the generated explanations for use in the user interface.

The server uses this interaction with a generative AI model to improve computer functionality in several ways. First, by querying the generative AI model with structured prompt sentences that embed behavior-based summaries, the server can automatically identify additional candidate features or training strategies that a human engineer might not have manually encoded, thereby improving prediction accuracy and reducing manual tuning time. Second, the server can generate explanation text that reduces user confusion and increases acceptance of the automated ranking, which in turn leads to more consistent usage patterns and richer training data, thereby enabling the server to continuously refine its internal models. Third, the server can use guidance from the generative AI model to selectively retrain or adjust models, rather than retraining all models at fixed intervals, thus reducing computational load and improving overall processing efficiency.

The server's architecture and data processing pipeline provide technical effects beyond mere automation of a human scheduling process. By storing behavior history information in structured tables with indexes optimized for query patterns, the server reduces latency in retrieving training data and real-time context statistics. By precomputing aggregate statistics and using cached representations of frequently accessed features, the server reduces the number of expensive database queries and the amount of data transferred between memory and storage, thereby improving throughput. By representing feature information in fixed-length numeric vectors compatible with vectorized operations, the server leverages hardware capabilities such as SIMD instructions and multi-core parallelism, resulting in faster model inference times and reduced response latency.

The use of trained prediction models also yields improved accuracy and efficiency compared with conventional rule-based or static-priority approaches. The models can capture non-linear relationships between temporal patterns, user-specific importance information, and execution behavior. For example, the model can distinguish that a particular activity should be prioritized on weekend mornings but de-prioritized on weekday mornings, based on observed completion rates and recency patterns. This fine-grained adaptation would be difficult to achieve using fixed heuristic rules and would require continuous manual adjustment. The server's model-based approach, combined with feature engineering and regular retraining, yields lower prediction error and more appropriate ranking decisions.

The server reduces communication load by selectively transmitting only necessary updates to the terminals. For example, when the server determines that the predicted ranking of elements has not significantly changed within a predefined threshold, the server can refrain from pushing an updated list, thereby avoiding unnecessary network traffic. Conversely, when the server detects substantial changes in suitability evaluation values due to new behavior history information or a major context shift, the server sends only the changed elements or their new positions, rather than retransmitting the entire list. These strategies result in reduced bandwidth usage and improved responsiveness, particularly in environments with limited network capacity.

The server, in some embodiments, applies non-conventional processing rules within its machine learning and reordering pipeline. For instance, the server may incorporate a penalty factor for elements that were repeatedly recommended but ignored, reducing their suitability evaluation values despite high historical frequency. The server may also apply time-decay functions to down-weight very old behavior history, as well as constraints that limit how often an element can be moved up or down in the list within a given timeframe to avoid excessive flickering in the user interface. These rules differ from standard sorting based solely on priority or deadline and are specifically designed to optimize both predictive performance and user experience.

The generative AI component is not used as a generic text generator but is tightly integrated into the system's control flow. The server constructs the prompt sentence with a predetermined structure, such as sections describing user behavior summaries, model performance metrics, and explicit questions regarding feature relevance or training strategy. The server then interprets the response information using parsing logic that identifies recommended feature additions, suggested re-weighting schemes, or new explanation templates. The server stores these results as configuration data that affect how feature vectors are constructed or how explanatory messages are generated for the user. This integration enables the system to improve its internal technical configuration over time based on high-level reasoning capabilities of the generative AI model.

In alternative embodiments, the server can employ different types of prediction models, such as gradient-boosted trees, logistic regression, or recurrent neural networks that explicitly model sequences of user actions. The feature set can also be extended to include additional contextual data, such as device battery level, connectivity type, or detected user location categories (home, office, public place), provided appropriate privacy controls are in place. The server can implement ensemble methods in which outputs from multiple models are combined, for example by weighted averaging or stacking, to further improve robustness and predictive performance.

The terminal side implementation can vary as well. In one embodiment, the terminal performs preliminary filtering based on locally cached rules, such as hiding expired tasks, before requesting a full ranking from the server. In another embodiment, the terminal caches the last received updated list information and applies minor reordering locally based on short-term signals, such as whether the user has opened a particular task multiple times within a short period. In such cases, the core suitability evaluation and model updates continue to be performed by the server, while the terminal performs lightweight adjustments to improve perceived responsiveness.

Through these configurations, the system achieves technical improvements in multiple dimensions. The server uses structured behavior history information and adaptive machine learning models to provide more accurate list rankings than conventional rule-based systems. The server uses precomputation, caching, and efficient feature representation to reduce processing time and communication overhead. The server integrates a generative AI model via carefully constructed prompt sentences to refine internal parameters and produce explanations, thereby improving not only user-facing behavior but also the internal design and tuning of the prediction pipeline. The combined effect is a system that improves computer technology itself through enhanced data management, more efficient computation, and improved model-driven control of the user interface rather than merely automating a human planning process.

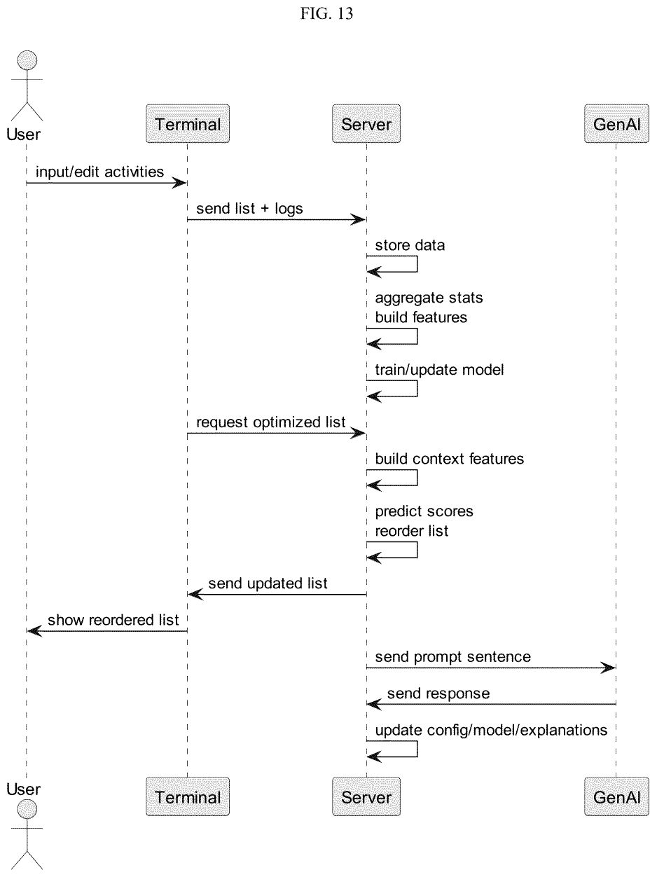

The following describes the processing flow using FIG. 13.

### Step 1

The user operates the terminal to create and update activity information.

The terminal displays an input screen that allows the user to enter titles, descriptions, and optional priority values for activities, and to add, edit, or delete list elements.

Input: touch or keyboard operations from the user.

The terminal converts the user operations into structured data, such as element identifiers, text strings, numeric priority values, and status flags.

The terminal stores this data in a local data structure, for example an array of records where each record includes an element identifier, a position index, and associated attributes.

Output: a locally updated list structure representing the current state of the user's activity list.

### Step 2

The terminal transmits the updated list structure and user actions to the server.

Input: the locally updated list structure and a log of user actions, such as element creation, completion, reordering, and deletion.

The terminal serializes this information into a request message, including user identifiers, element identifiers, new position indices, timestamps, and action types.

The terminal sends the request to the server via a secure communication channel.

Output: a network message containing list data and behavior history information delivered to the server.

### Step 3

The server receives and stores list data and behavior history information.

Input: the request message from the terminal containing list elements and action logs.

The server parses the message, validates required fields, and maps external identifiers to internal identifiers.

The server writes list element records to a list table and behavior logs to a behavior_log table in a database, including user identifiers, element identifiers, timestamps, and action types.

The server may update index structures on the database tables to support efficient queries.

Output: normalized and persisted list data and behavior history information stored in the database.

### Step 4

The server aggregates behavior history information to compute usage statistics.

Input: records from the behavior_log table and element metadata from the list table.

The server executes queries that group behavior records by user identifier, element identifier, day-of-week, and time-of-day slot.

The server counts occurrences of each action type, computes recency-weighted scores by applying a decay function to timestamps, and calculates average completion rates for each temporal context.

The server stores the resulting aggregated statistics in an aggregate table or in a memory-resident data structure.

Output: usage statistics for each element, including overall frequency, context-specific frequency, and recency-weighted scores.

### Step 5

The server generates feature information for machine learning processing.

Input: usage statistics, user-assigned priority values, temporal attributes (such as day-of-week and time slot), and element metadata.

The server converts categorical fields, such as day-of-week and time slot, into one-hot encoded vectors and normalizes numeric fields such as completion counts and recency scores.

The server concatenates these values into fixed-length feature vectors representing (user, element, context) combinations.

The server associates each feature vector with a target label, such as a binary indicator of whether the element was executed in a similar context or a numeric suitability score derived from historical execution.

Output: a training dataset consisting of feature vectors and corresponding target labels.

### Step 6

The server trains a prediction model using the feature information.

Input: the training dataset of feature vectors and target labels.

The server initializes model parameters for a chosen algorithm, for example a decision-ensemble model or a neural network, and splits the data into training and validation subsets.

The server iteratively adjusts the model parameters by minimizing a loss function computed over the training subset, using optimization methods such as gradient-based updates.

The server evaluates the model on the validation subset and selects hyperparameter values that yield improved performance.

The server stores the trained model parameters and associated configuration in persistent storage.

Output: prediction model information capable of outputting suitability evaluation values given feature vectors.

### Step 7

The terminal requests an optimized list from the server at runtime.

Input: the current list state and the current context (including timestamp and optional location) as held by the terminal.

The terminal constructs a request message containing the user identifier, identifiers of current list elements, their base order, and current context parameters.

The terminal sends this message to the server through the communication network.

Output: a request for ranking that the server can use to compute an optimized order.

### Step 8

The server generates context-aware feature vectors for the current list.

Input: the request for ranking, including current list elements and context parameters, and the stored usage statistics and configuration.

The server determines current temporal attributes, such as the present day-of-week and time-of-day slot, and retrieves aggregate statistics for the specified user and elements.

The server constructs feature vectors for each element by combining current context features, usage statistics, and user-assigned priority values.

The server applies the same encoding and normalization rules used during training so that the features match the model's expected input.

Output: a set of feature vectors representing the current elements under the current context.

### Step 9

The server calculates suitability evaluation values using the trained prediction model.

Input: the set of context-aware feature vectors and the stored prediction model information.

The server loads the model parameters into memory and executes inference operations, such as matrix multiplications and non-linear activations in the case of a neural network, or tree traversals in the case of an ensemble of decision trees.

The server computes, for each feature vector, a scalar value representing the predicted suitability or execution probability of the corresponding element.

The server associates each suitability evaluation value with its corresponding element identifier.

Output: a mapping from element identifiers to suitability evaluation values.

### Step 10

The server reorders the list based on the suitability evaluation values.

Input: the mapping from element identifiers to suitability evaluation values and the current list structure.

The server sorts the elements in descending order of suitability evaluation values, optionally applying additional rules such as penalizing items repeatedly ignored or constraining how much an item's position can change in a single update.

The server constructs updated list information, including the new position of each element and optional metadata such as the computed suitability score and relevant context.

Output: updated list information representing the reordered list for the current context.

### Step 11

The server sends the updated list to the terminal and the terminal displays it to the user.

Input: the updated list information generated by the server.

The server formats the updated list information into a response message and transmits it to the terminal.

The terminal receives the response, parses the updated positions and metadata, and updates its local data structure so that the display order matches the server's adjusted order.

The terminal renders the reordered list on the display and may highlight items with high suitability scores or explain context (for example, “recommended for this time”).

Output: a visual presentation of the optimized list to the user on the terminal.

### Step 12

The server generates a prompt sentence for a generative AI model based on behavioral summaries.

Input: behavior tendency information, usage statistics, time zone information, and current model performance indicators.

The server constructs a text prompt that combines a structured summary of user behavior with explicit questions about optimization strategies or explanations.

The server may, for example, create a prompt sentence such as:

“Based on the following user behavior summary: the user completes ‘Go to the library’ mostly on Saturday afternoons and rarely on weekdays, and the user frequently completes ‘Grocery shopping’ on weekday evenings, propose a method to optimize the order of the user's task list for different days and times, and explain the reasoning in plain language.”

The server includes this text in a request to a generative AI model.

Output: a prompt sentence and a corresponding request message ready to be sent to the generative AI model.

### Step 13

The server obtains and utilizes response information from the generative AI model.

Input: the prompt sentence and the response text returned by the generative AI model.

The server sends the prompt sentence to the generative AI model via an application programming interface and receives response information that may describe suggested feature modifications, weight adjustments, or explanatory messages.

The server parses the response, extracts actionable elements such as specific feature suggestions or explanation templates, and stores these elements as configuration data.

The server may update internal parameters governing feature generation or explanation display, or may store explanation text to be associated with particular ranking decisions and shown to the user through the terminal.

Output: refined configuration for the prediction pipeline and/or explanation content derived from the generative AI model's response.

### Step 14

The server periodically updates the prediction model using newly accumulated data and applied improvements.

Input: newly collected behavior history information, updated usage statistics, and configuration changes influenced by response information from the generative AI model.

The server re-runs aggregation and feature generation using the expanded dataset, and retrains or fine-tunes the prediction model to incorporate recent user behavior and any newly introduced features or weighting schemes.

The server evaluates the updated model, and, if performance is improved beyond a threshold, replaces the deployed model version with the new one.

The server thereby reduces prediction error, adapts to behavior shifts, and improves computational efficiency by focusing retraining efforts where they yield measurable gains.

Output: an updated prediction model and associated configuration that enhance the accuracy and stability of suitability evaluation and list reordering.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional planning and recommendation systems that run on generic computing platforms typically treat user input lists, behavioral logs, and recommendation logic as loosely coupled components. A user often inputs a list of activities or destinations through a graphical user interface, and a backend system statically reorders the list based on hard-coded rules or simple statistical ranking. Such systems generally do not close the loop between (i) how the user interface captures user reordering behavior, (ii) how a machine learning model structurally represents user behavior patterns over time, and (iii) how a generative AI model is prompted and adapted using those learned patterns. As a result, the underlying computation is suboptimal, and the computer resources are not used efficiently to generate high-quality, context-aware plans.

In particular, existing systems exhibit at least the following technical problems. First, the processor typically executes separate modules for rule-based sorting, machine learning prediction, and natural language generation, without a unified representation of user behavior history, time-zone context, and emotion state. This fragmented architecture leads to redundant data conversions, inconsistent models, and increased memory and processing overhead. Second, the prompt sentence supplied to a generative AI model is usually hand-crafted or static, and does not systematically reflect updated user behavior patterns or feedback. This causes the generative AI model to operate on incomplete or stale context, thereby limiting the precision and stability of its outputs and resulting in inefficient use of computational resources. Third, feedback from user corrections in the user interface such as drag-and-drop reordering of list items is rarely fed back into the behavior models and prompt construction logic in a structured, machine-interpretable manner. Consequently, the system fails to adapt its internal models and continues to perform repetitive or unnecessary computations that do not converge toward the user's actual preferences.

Furthermore, conventional processors do not integrate emotion state information and external environment information (such as time-zone context, schedule information, or other environmental data) at the feature level for coordinated use by both discriminative machine learning models and generative AI models. This lack of integrated feature engineering and joint use of models prevents the processor from leveraging the full discriminative power of predictive models together with the expressive reasoning capabilities of generative models. As a result, the computing system cannot reliably generate optimized plan information, such as item display order and execution time zones, with high computational efficiency and high relevance to the user's context.

Accordingly, there is a need for a technical solution that improves computer operation by: (i) structurally capturing list operations, behavior history, time-zone information, emotion state, and environment information as unified features; (ii) learning a behavior pattern model with those features; (iii) automatically generating and updating prompt sentences for a generative AI model based on the same feature set; and (iv) integrating the outputs of the discriminative model and the generative AI model into optimized plan information. Such a solution should reduce redundant processing, improve the quality and stability of recommendations, and provide a technical improvement to the functioning of the processor and the overall computing system, rather than merely automating a human mental process.

The specific processing by the specific processing unit 290 of the data processing device 12 in Application Example 2 is realized by the following means.

The present invention provides a server comprising a processor and a memory storing instructions which, when executed by the processor, cause the processor to provide, to an information processing device, a user interface that displays, in a list format, behavior information input by a user through the information processing device and that allows the user to change an order of items in the list by a drag-and-drop operation; to transmit, via a communication line, list information after the order change and user identification information to a computation device; to cause the computation device to store the list information in a storage device, to cause the computation device to acquire past behavior history information and time-zone information of the user, and to cause the computation device to generate a behavior pattern model by performing machine learning processing using the past behavior history information and the time-zone information; to cause the computation device to execute calculation processing for predicting a display order and an execution time zone of the items in the list based on the behavior pattern model; to cause the computation device to generate a prompt sentence for a generative artificial intelligence model from summary explanation information obtained by summarizing the behavior history information, emotion state information, the time-zone information, and the list information; to cause the computation device to input the prompt sentence into the generative artificial intelligence model, to cause the computation device to acquire a recommended order and a recommended time zone from the generative artificial intelligence model, and to cause the computation device to integrate the recommended order and the recommended time zone with a prediction result obtained by the machine learning processing to generate optimized plan information; and to transmit the optimized plan information to the information processing device, to cause the information processing device to visually present, on the user interface, the display order of the items and the recommended time zone based on the optimized plan information, to receive a correction operation from the user, to transmit a correction result to the computation device as behavior history information, and to cause the computation device to perform feedback processing in which the behavior pattern model and generation of the prompt sentence are updated based on the behavior history information. This enables the computing system to improve its internal operation by unifying feature generation for both discriminative and generative models, by adaptively optimizing prompt sentences based on learned behavior and feedback, and by reducing redundant and inconsistent computations, thereby enhancing the efficiency and accuracy with which the processor generates context-aware, optimized plans.

The term “system” refers to a combination of hardware and software components including at least one processor, at least one memory, and one or more communication interfaces, configured to execute the claimed processing collectively.

The term “processor” refers to an electronic circuitry such as a central processing unit or a graphics processing unit that executes instructions stored in a memory to perform arithmetic operations, logical operations, control operations, and data transfer operations.

The term “memory” refers to a non-transitory computer-readable storage medium, such as a semiconductor memory, magnetic storage, or optical storage, that stores instructions and data for access by the processor.

The term “information processing device” refers to a client-side electronic apparatus, such as a personal computer, a smartphone, or a tablet device, that provides a user interface and communicates with the server or computation device over a network.

The term “computation device” refers to a server-side or network-side electronic apparatus, which may be implemented by one or more physical or virtual machines, that executes machine learning processing, generative artificial intelligence processing, and other backend computations.

The term “storage device” refers to a data storage apparatus, such as a database system or file system, that stores list information, behavior history information, models, and other persistent data.

The term “user interface” refers to a graphical or interactive presentation and input mechanism provided on the information processing device, through which a user can view lists, plans, and recommendations and can perform operations such as dragging, dropping, and selecting items.

The term “behavior information” refers to information indicating planned or actual actions of a user, such as activities, tasks, or visits to locations, including associated attributes such as labels, categories, and desired time ranges.

The term “list” refers to an ordered collection of items representing behavior information, managed as a data structure whose order can be changed and which is displayed on the user interface.

The term “item” refers to an individual element of a list, such as a single activity, task, product, or destination, which can be selected, reordered, and associated with time and other attributes.

The term “drag-and-drop operation” refers to a user interface operation in which a user selects an item in the list, moves the item to a different position by a pointing or touch operation, and releases the item, thereby changing the order of items.

The term “list information” refers to data representing the contents and structure of a list, including item identifiers, item attributes, and positional information indicating the order of the items.

The term “user identification information” refers to data that uniquely or pseudo-uniquely identifies a user within the system, such as an identifier, token, or account name.

The term “communication line” refers to a wired or wireless communication path, including local area networks, wide area networks, or the Internet, over which data is transmitted between the information processing device and the computation device.

The term “past behavior history information” refers to recorded data of previous actions, selections, completions, and related context of the user, including timestamps and associated items, accumulated over time.

The term “time-zone information” refers to information indicating temporal segments related to user behavior, including absolute times, dates, time zones, or derived time segments such as morning, afternoon, or evening.

The term “emotion state information” refers to data representing an estimated or declared emotional condition of the user, such as stress, joy, or relaxation, optionally expressed as labels or numerical scores.

The term “environment information” refers to external context information obtained from an external information providing device, such as traffic conditions, congestion levels, inventory status, weather, or other situational data relevant to planning.

The term “behavior pattern model” refers to a data structure or set of parameters generated by machine learning processing that characterizes statistical or predictive relationships between user behavior, time-zone information, emotion state information, and other features.

The term “machine learning processing” refers to computational procedures that adjust parameters of a model based on training data, such as supervised learning, unsupervised learning, or reinforcement learning, in order to predict or classify future behavior.

The term “calculation processing” refers to computational operations that apply one or more models or algorithms to input data to produce outputs such as predicted display order, execution time zones, or evaluation scores.

The term “display order” refers to a sequence in which items in a list are arranged and presented on the user interface, which may be optimized based on model outputs.

The term “execution time zone” refers to a proposed or predicted temporal interval or segment during which a given item is recommended to be executed or scheduled.

The term “summary explanation information” refers to data generated by condensing or aggregating behavior history information, emotion state information, time-zone information, and list information into a compact representational form suitable for inclusion in a prompt sentence.

The term “prompt sentence” refers to a textual input sequence provided to a generative artificial intelligence model, describing context, constraints, or instructions, in order to elicit a desired generated output.

The term “generative artificial intelligence model” refers to a trained computational model, such as a large language model or other generative model, that generates text or structured data in response to a prompt sentence.

The term “recommended order” refers to a sequence of items suggested by the generative artificial intelligence model, the behavior pattern model, or their combination, indicating a preferred arrangement of items.

The term “recommended time zone” refers to one or more temporal intervals suggested by the generative artificial intelligence model, the behavior pattern model, or their combination, indicating preferred times for execution of items.

The term “optimized plan information” refers to structured data representing an integrated result that combines predicted or recommended display order, recommended time zones, and associated metadata, derived from both machine learning processing and generative artificial intelligence processing.

The term “correction operation” refers to an action performed by the user on the user interface to modify the system's recommendation, such as reordering items, changing suggested time zones, or editing attributes.

The term “correction result” refers to data representing the state of the list, items, or time zones after the user performs a correction operation, which is used as new behavior history information.

The term “feedback processing” refers to computational procedures that update the behavior pattern model and prompt sentence generation logic based on new behavior history information, including correction results and execution outcomes.

The term “execution result information” refers to data describing whether and how an item was actually executed, including completion times, durations, success indicators, or user evaluations.

The term “feature set” refers to a collection of feature values derived by integrating schedule information, item information, behavior history information, emotion state information, and environment information, used as input to a model or prompt sentence.

The term “schedule information” refers to data describing planned or existing time allocations for user activities, such as calendar entries, reserved time slots, or deadlines.

The term “item information” refers to attributes associated with each item in the list, such as category, priority, estimated duration, location, or required resources.

The term “candidate time zone” refers to a temporal interval or segment proposed by the generative artificial intelligence model as a possible execution time for an item before final optimization.

### A. Overall Configuration

The server includes a multi-core central processing unit, a main memory, a non-volatile storage device, and a network interface. The server executes an operating system such as a general-purpose server operating system and runs application software implemented, for example, in a high-level programming language. The server further hosts a database management system such as a relational database system that manages tables for list information, behavior history, emotion logs, schedule information, and model parameters.

The terminal includes a processor, a display, an input device such as a touch panel, a microphone, a camera, a local memory, and a wireless or wired communication interface. The terminal executes a client application implemented, for example, as a native mobile application using a graphical user interface framework. The terminal displays a list of items to the user and transmits and receives data to and from the server via a communication network.

The server and the terminal communicate via a communication line such as a packet-switched network. The server provides an application programming interface (API), for example, a RESTful API, that accepts and returns structured data. The server stores and retrieves data in the storage device using data access libraries. The server invokes a generative AI model via an external generative AI service or a locally deployed generative model.

### B. User Interface and List Data Structures

The terminal provides a user interface that displays behavior information in a list format. The terminal represents the list as an ordered sequence of item records in local memory. Each item record includes at least an item identifier, a textual label, a category, an estimated duration, an optional location attribute, a priority score, and a current position index within the list. The terminal maintains the list as an array or linked structure that can be reordered.

The terminal allows the user to perform a drag-and-drop operation on any list item. When the user touches and holds an item on the display and moves it to another position, the terminal updates the positional indices of affected items in local memory. The terminal then serializes the list information, including the updated order, together with user identification information and a timestamp, into a structured data format and transmits this list information to the server.

The server receives list information and stores it in the storage device. The server writes records into a list table, which includes fields such as a user identifier, an item identifier, an item label, a category code, an estimated duration, a priority value, and an order index. By using positional indices, the server can reconstruct the user-defined ordering without ambiguity. This specific data structure allows the server to track how the user intentionally reorders items over time, which provides informative training signals for behavior modeling.

### C. Behavior History, Schedule, and Emotion Data Management

The server manages a set of tables in the database, including a behavior history table, an emotion log table, a schedule table, and a model metadata table. The behavior history table stores for each user identifier records of past actions, such as executed items or confirmed plans, with associated timestamps, durations, and completion flags. The schedule table stores time intervals reserved for planned activities, calendar entries, and deadlines. The emotion log table stores emotion state information, such as an emotion label and a set of numeric emotion scores, together with timestamps and references to related items.

The terminal acquires emotion state information by accepting text input describing feelings, capturing audio segments, or acquiring facial images with the camera. The terminal transmits this raw emotion data or preliminary features to the server. The server applies an emotion recognition module implemented, for example, as a neural network classifier trained on text or image features. The server thereby obtains an emotion label such as “stressed”, “relaxed”, or “motivated” and associated confidence scores. The server stores these values in the emotion log table.

By combining list information, behavior history, schedule information, and emotion state information in structured tables, the server can construct feature vectors that capture temporal context, user preferences, and emotional conditions. This integrated data representation is a technical improvement over conventional systems that treat these elements in isolation, because it reduces redundant storage and enables more efficient queries aligned with the subsequent model computations.

### D. Behavior Pattern Model and Feature Engineering

The server generates a behavior pattern model by applying machine learning processing to the data stored in the storage device. The server constructs feature vectors for each relevant past event or list item. The server includes as features, for example:

Encoded time-zone information derived from timestamps (hour of day, day of week, weekend/weekday, and categorical segments such as “morning”, “afternoon”, and “evening”).

Encoded item attributes (category, estimated duration, location type, and priority).

Aggregated behavior history statistics (frequency of selection for each item or category in each time-zone segment, average completion rate, average delay from planned time to execution time).

Emotion features (probability scores for emotion labels such as stress, joy, and fatigue, and derived features such as average stress level for a given category in a particular time segment).

Schedule context (density of planned activities around candidate time windows, availability of free time blocks, and conflict indicators).

The server converts categorical attributes into numerical vectors using encoding methods such as one-hot encoding or learned embeddings. The server normalizes continuous features such as durations and counts to stabilize training. The server concatenates all feature components into a fixed-length feature vector that can be directly consumed by a machine learning model. This explicit feature construction aligns both the discriminative model and the generative AI prompt generation with the same feature set, ensuring consistent semantics across modules.

In one embodiment, the server implements a neural network classifier as the behavior pattern model. The server defines a feedforward neural network with an input layer corresponding to the dimension of the feature vector, one or more hidden layers, and an output layer that yields scores representing selection probabilities or utility values for candidate items and time zones. The server uses a rectified linear unit activation function in the hidden layers, and a softmax or sigmoid activation in the output layer depending on the prediction task. The server trains this model using a supervised learning algorithm with a cross-entropy loss function for classification or a mean squared error function for regression. The server updates the network weights using a gradient-based optimization algorithm such as stochastic gradient descent or an adaptive variant. The server may employ mini-batch training, learning rate scheduling, and regularization techniques.

By using this neural network with engineered feature vectors, the server can capture complex, non-linear relationships between time-zone context, behavior history, emotion state, and item attributes that would be difficult or impractical for a human to define as static rules. This processing does not merely replicate human planning; rather, it exploits high-dimensional pattern recognition and parameter optimization that enhance prediction accuracy and reduce errors compared to rule-based sorting.

### E. Generative AI Model and Prompt Sentence Construction

The server interacts with a generative AI model that generates textual or structured recommendations. The server constructs a prompt sentence by summarizing relevant feature sets and model outputs into a natural-language representation. The server generates, for example, a prompt sentence of the following type:

“User behavior summary: often executes exercise activities in the early morning and concentrates best on work tasks in the afternoon. Current time: 7:00 a.m. Candidate activities: jogging, preparing a presentation, reading, shopping for groceries. Emotion: slightly stressed. Based on this information, propose an ordered list of activities with suggested time slots that reduces stress and maintains productivity.”

The server also generates prompt sentences for other scenarios, such as:

“User behavior summary: frequently orders heavy meals at lunchtime and light snacks in the evening. Current time: 7:00 p.m. Candidate items: ramen, salad, burger, coffee. Emotion: relaxed. Based on this information, propose an ordered menu list that maximizes satisfaction and health balance.”

The server constructs the prompt sentence by inserting values derived from the feature vectors, the behavior pattern model outputs, and the schedule context. The server thereby ensures that the generative AI model receives up-to-date, structured contextual information in a consistent textual form. The server sends this prompt sentence to the generative AI model via an interface. The server obtains a generated text response that includes a recommended order of items, suggested time-zones, and explanations.

The server parses the response to extract explicit ranking and time assignments. The server may use simple parsing rules or an additional parsing model. By embedding structured context into the prompt sentence and systematically extracting structured outputs, the server achieves a reproducible and machine-interpretable interaction with the generative AI model. This approach improves upon static, hand-crafted prompts by continuously adapting the prompt content to the evolving behavior pattern model and user feedback.

### F. Integration of Discriminative and Generative Outputs

The server integrates the outputs of the behavior pattern model and the generative AI model to produce optimized plan information. The server obtains from the behavior pattern model numerical scores that represent predicted selection probabilities or expected utility for each candidate item in specific time segments. The server obtains from the generative AI model a recommended ordering and candidate time intervals.

The server combines these two types of information using a non-trivial integration algorithm. For example, the server assigns a weight to the discriminative model scores and a weight to the generative ranking, and computes a combined score for each candidate item and time-zone pair. The server may penalize combinations that conflict with the user's schedule or exceed available time blocks. The server may also adjust scores based on emotion features, such that stress-reducing activities receive higher scores in high-stress conditions.

By using this joint scoring method, the server selects a final display order and execution time-zones that reflect both learned statistical patterns and generative reasoning. This technique improves the technical functioning of the system in several ways. The server reduces the number of candidate combinations that must be evaluated by pruning low-scoring options early, thereby decreasing computation time. The server also reduces communication load by transmitting only the final optimized plan rather than multiple intermediate recommendations. The integrated approach yields a more stable and consistent plan, reducing oscillations and contradictions that might arise if separate modules independently propose conflicting suggestions.

### G. Feedback and Online Adaptation

The terminal presents the optimized plan information by displaying the list items in the recommended order and annotating them with suggested execution time-zones. The user may accept the plan or modify it by dragging items to new positions or adjusting suggested times. The terminal transmits the correction result, including the final order and any updated times, to the server.

The server treats the correction result as new behavior history information. The server appends this information to the behavior history table and optionally assigns higher weight to such feedback examples during subsequent training iterations. The server also updates statistics such as how often the user overrides specific recommendations or time-zones. The server uses this updated data to retrain or fine-tune the behavior pattern model, and to adjust the structure and emphasis of subsequent prompt sentences. For example, if the user regularly moves a certain category of tasks earlier in the day, the server modifies prompt sentences to state that the user “prefers to perform this category earlier in the morning” and adjusts features accordingly.

This closed feedback loop is not a simple automation of human decision-making. The server uses the correction results to adapt internal model parameters, feature weights, and prompt templates in a systematic manner. The server thereby reduces future prediction errors and shortens the convergence time required to match the user's evolving preferences. The result is an objective improvement in model accuracy, reduced need for repeated user corrections, and better utilization of computation resources by focusing processing on promising candidate plans.

### H. Technical Effects and Compliance with Computer-Technology Improvement

The described embodiment provides a technical improvement to the operation of the server and the terminal. By unifying list representation, behavior history, schedule, emotion state, and environment information into a structured feature set, the server reduces redundant data conversions and storage operations. By implementing a specifically configured behavior pattern model that uses these feature sets and integrates its outputs with a generative AI model through carefully constructed prompt sentences and integration algorithms, the server improves the precision and stability of the generated plans.

Further, by using a neural network architecture with defined layers, activation functions, and optimization procedures, and by employing explicit loss functions and feature normalization, the server executes computations in a way that is not conventional rule-based automation. The server controls data flows, memory usage, and computation paths to minimize unnecessary operations and to optimize cache and batch processing patterns. This yields measurable improvements in processing speed and reduces communication overhead by decreasing the frequency and size of data exchanges between server and terminal.

The system also improves data management by maintaining distinct but linked tables for list information, behavior history, emotion logs, and model metadata. This structure enables targeted queries and incremental updates rather than full reprocessing, enhancing scalability. The server can update the behavior pattern model using only newly collected feedback data, which improves computational efficiency and reduces latency.

Because the server uses AI models to transform high-dimensional feature data in ways that would not be practicable for manual processing, and because the server's algorithms adapt internal parameters and prompt constructions based on feedback, the system goes beyond mere automation of human planning. The architecture and data flows are configured explicitly to improve the internal functioning of the computing system itself reducing error, improving convergence, and optimizing resource allocation thereby providing a technical solution to the issues identified earlier.

### I. Variations and Alternative Embodiments

The server may employ alternative machine learning models, such as gradient boosted decision trees, support vector machines, or recurrent neural networks, provided that these models accept the constructed feature sets and output scores or probabilities that can be combined with generative AI outputs. The neural network architecture may include additional hidden layers, dropout layers, or attention mechanisms, and the learning algorithm may be modified to use different optimization methods or regularization techniques.

The generative AI model may reside on an external service or on a local inference engine. The server may use alternative prompt sentence formats, for example, including structured bullet lists or explicit key-value descriptions, as long as the prompt sentence still describes behavior history, schedule context, and model predictions in a machine-interpretable way. Example prompt sentences may include:

“Based on the user's schedule: jogging, preparing a presentation, reading, and shopping for groceries, and based on the user's tendency to be most focused in the afternoon and to feel stressed in the evening, propose an optimal ordering of these activities and recommended time slots for tomorrow.”

“Using the user's updated history where stress is reduced after evening walks and concentration peaks around 3 p.m., propose an improved plan for tomorrow's tasks and suggest optimal time slots for each task.”

The terminal may be implemented as a web browser application or a desktop application instead of a mobile application. The server may operate on a distributed cluster or a virtualized environment. In all such variations, the server, the terminal, and the user still cooperate in the manner described above, and the same principles of feature construction, model training, prompt generation, and integrated optimization apply.

By providing these embodiments and variations, the specification enables a person skilled in the art to implement the claimed invention on a variety of hardware and software platforms while maintaining the core technical features: unified data representations, behavior pattern modeling, adaptive prompt sentences to a generative AI model, and integrated optimization that improves the internal operation of the computing system.

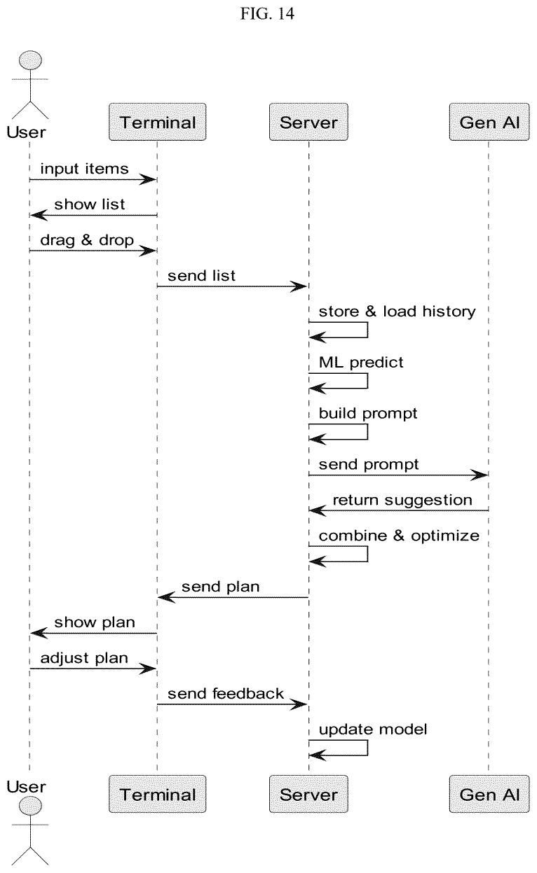

The following describes the processing flow using FIG. 14.

### Step 1

The user operates the terminal to input behavior information as list items. The input includes item labels, categories, estimated durations, and optional preferred time ranges. The terminal receives this input from the display and input device and constructs an internal list data structure in memory, where each element contains an item identifier, textual label, category code, estimated duration, and an initial order index. The terminal outputs the constructed list data structure as in-memory records ready for display and transmission.

### Step 2

The terminal displays the list to the user on the screen. The input to this step is the in-memory list data structure from Step 1. The terminal uses a graphical user interface framework to render each item as a visual row with its label and attributes, ordered according to the order indices. The terminal outputs a rendered user interface that allows the user to view the list and perform drag-and-drop operations.

### Step 3

The user performs drag-and-drop operations on the terminal to reorder items. The input to this step is the displayed list and the user's touch or pointing actions. The terminal detects a selection of an item, tracks the movement of the touch, and determines a new insertion position when the user releases the item. The terminal updates the order indices of affected items in its internal list data structure and outputs an updated list with revised positional indices that reflect the user's intended order.

### Step 4

The terminal transmits the updated list information and user identification information to the server. The input to this step is the updated list data structure and a stored user identifier. The terminal serializes the list into a structured payload including item identifiers, attributes, and order indices, and sends this payload via a communication interface over a network using a request protocol. The terminal outputs a network message that serves as the server's input for subsequent processing.

### Step 5

The server receives the network message and stores the list information in a storage device. The input to this step is the serialized list payload and user identifier received over the network. The server parses the payload, validates the schema, and converts the data into database records. The server executes insert or update commands on a list table, writing fields such as user identifier, item identifier, label, category, estimated duration, and order index. The server outputs persistent records in the storage device that represent the current user-defined list order.

### Step 6

The server retrieves behavior history information and time-zone information for the same user from the storage device. The input to this step is the user identifier and an internal query request. The server performs queries against behavior history and schedule tables to obtain past execution records, timestamps, completion flags, and existing calendar entries. The server processes the raw timestamps to derive temporal features such as hour of day, day of week, and time-segment labels (for example, morning, afternoon, evening). The server outputs a set of structured history records enriched with derived time-zone attributes.

### Step 7

The server collects emotion state information associated with the user. The input to this step is either new emotion data received from the terminal or previously recorded emotion logs linked to the user identifier. The server, if receiving new raw emotion data, applies an emotion recognition module to convert text, audio, or image features into an emotion label and numeric scores. The server then consolidates these values with related history entries. The server outputs a collection of emotion records, each containing a timestamp, an emotion label, and a vector of emotion scores that can be joined with behavior history.

### Step 8

The server constructs feature vectors for behavior pattern modeling. The input to this step is the enriched behavior history records from Step 6, the emotion records from Step 7, the stored list information from Step 5, and schedule information from the schedule tables. The server encodes categorical attributes (item categories, time segments, emotion labels) into numerical representations and normalizes continuous values (durations, counts, emotion scores). The server aggregates per-item statistics such as selection frequency per time segment and average completion rates. The server then concatenates these components into fixed-length numerical feature vectors. The server outputs a feature matrix and associated target labels (for example, past selections or completion outcomes) suitable for model training or inference.

### Step 9

The server applies a behavior pattern model to predict item scores and time-zone suitability. The input to this step is the feature matrix for candidate items under current context and, when training, target labels. The server loads a trained neural network or other machine learning model and, for inference, feeds the feature vectors through the model layers to compute output scores representing selection probabilities or utilities for each item and time segment. If training is required, the server computes a loss function and adjusts model weights using an optimization algorithm. The server outputs, for the current session, predicted scores for each item and candidate time-zone, and optionally updated model parameters for storage.

### Step 10

The server composes summary explanation information to be used in a prompt sentence for a generative AI model. The input to this step is the predicted scores from Step 9, the feature data for the current list, behavior history summaries, schedule context, and emotion state information. The server selects salient attributes, such as “often executes jogging in early morning” or “tends to complete work tasks in afternoon,” by analyzing high-scoring patterns and frequent behaviors. The server converts these internal findings into concise textual phrases and aggregates them into a structured narrative description. The server outputs summary explanation text that describes the user's habits, current time, candidate items, and emotional condition.

### Step 11

The server generates a prompt sentence for a generative AI model based on the summary explanation information. The input to this step is the summary explanation text from Step 10 and the current list of candidate items. The server constructs a natural-language prompt that embeds the explanation and lists the candidate items and constraints. For example, the server may form a prompt sentence such as:

“User behavior summary: often executes exercise activities in the early morning and concentrates best on work tasks in the afternoon. Current time: 7:00 a.m. Candidate activities: jogging, preparing a presentation, reading, shopping for groceries. Emotion: slightly stressed. Based on this information, propose an ordered list of activities with suggested time slots that reduces stress and maintains productivity.”

The server outputs the complete prompt sentence as a text string ready to be sent to the generative AI model.

### Step 12

The server sends the prompt sentence to a generative AI model and receives a generated recommendation. The input to this step is the prompt sentence text from Step 11. The server transmits the prompt to the generative AI model via a network or local interface and specifies generation parameters such as maximum response length and randomness settings. The generative AI model returns a generated text response that typically includes an ordered list of items, suggested time-zones, and explanatory reasoning. The server outputs the received response text for further parsing and integration.

### Step 13

The server parses the generative AI model's response to extract a recommended order and candidate time-zones. The input to this step is the generated response text from Step 12. The server applies parsing logic to identify item names or identifiers, associated recommended time-zones, and any priority or rationale statements. The server maps textual item references back to internal item identifiers using label matching or an index. The server outputs a structured representation of the generative AI recommendations, including a recommended order index for each item and proposed execution time intervals.

### Step 14

The server integrates the behavior pattern model outputs with the generative AI recommendations to produce optimized plan information. The input to this step is the predicted scores from Step 9 and the structured generative recommendations from Step 13. The server computes a combined score for each item and time-zone by applying a weighted function that balances the discriminative model's scores and the generative ranking, optionally adjusted for schedule conflicts and emotion-based priorities. The server selects the highest-scoring combination of item ordering and time-zones that fits within available schedule windows. The server outputs optimized plan information, which includes a final display order, assigned execution time-zones, and optional tags or explanations.

### Step 15

The server transmits the optimized plan information to the terminal. The input to this step is the optimized plan data structure from Step 14 and the user identifier. The server serializes the plan into a response payload, including for each item its identifier, display label, final position index, and recommended time-zone. The server sends this payload through the communication line back to the terminal. The server outputs a network response that the terminal can decode and use to update the user interface.

### Step 16

The terminal updates the displayed list and annotations based on the optimized plan information. The input to this step is the plan payload from Step 15. The terminal parses the payload and maps item identifiers to UI elements. The terminal reorders the visual list according to the final position indices and displays recommended time-zones as textual labels or icons next to each item. The terminal may also highlight priority items using visual cues. The terminal outputs an updated user interface showing the optimized plan to the user.

### Step 17

The user reviews the optimized plan and may perform correction operations. The input to this step is the updated display showing item order and recommended times. The user can choose to accept the plan or override parts of it by dragging items to new positions or editing suggested times. The terminal captures these interactions and updates its internal list data structure and time assignments accordingly. The terminal outputs corrected list and time data that reflect the user's final decisions.

### Step 18

The terminal transmits the correction result to the server as feedback. The input to this step is the corrected list order, updated time-zones, and the user identifier. The terminal packages this information into a feedback payload, including flags indicating which recommendations were changed. The terminal sends this payload to the server over the network. The terminal outputs a feedback message that the server uses to improve subsequent processing.

### Step 19

The server records the correction result as new behavior history information and updates statistical summaries. The input to this step is the feedback payload from Step 18. The server writes new records into the behavior history table indicating which items were accepted or overridden and how suggested times were modified. The server updates aggregated statistics such as override frequencies per item or category. The server outputs updated database records and revised statistics that will influence future feature construction.

### Step 20

The server updates the behavior pattern model and the prompt generation strategy based on the new behavior history. The input to this step is the updated history and statistical summaries from Step 19. The server may perform incremental training by constructing new feature vectors from the feedback examples and applying additional optimization steps to the model weights, or by adjusting importance weights assigned to certain features. The server also adjusts the templates and emphasis used when constructing prompt sentences, for example, by reflecting persistent user preferences in the textual summaries. The server outputs a refined model and updated prompt construction parameters, thereby improving prediction accuracy and making future prompt sentences more representative of the user's evolving behavior.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

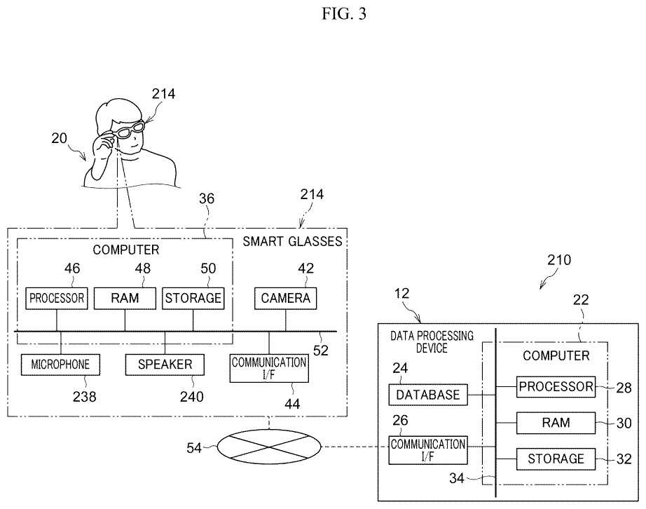

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

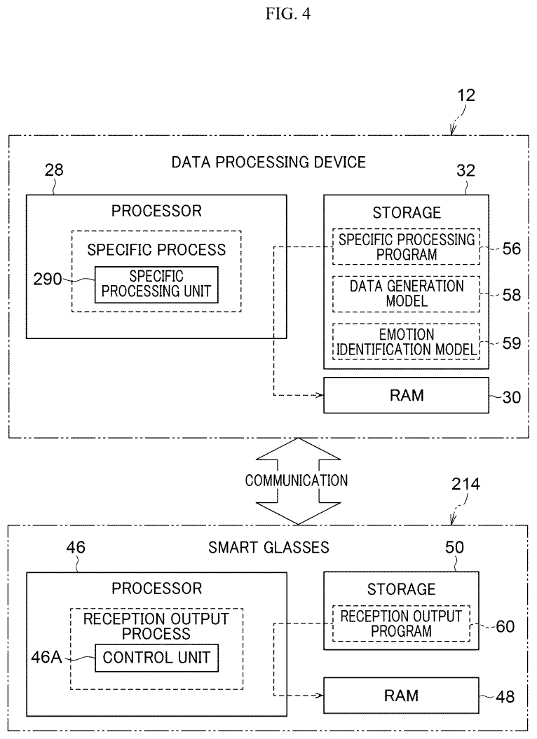

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

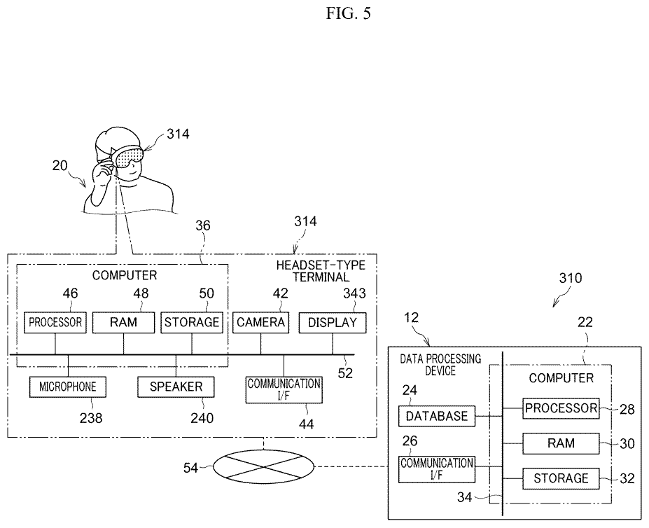

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

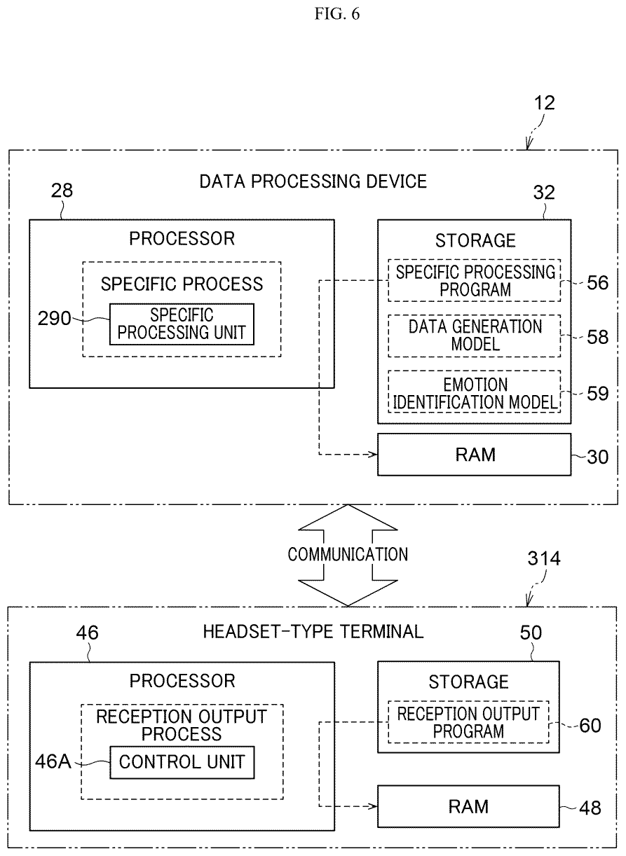

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

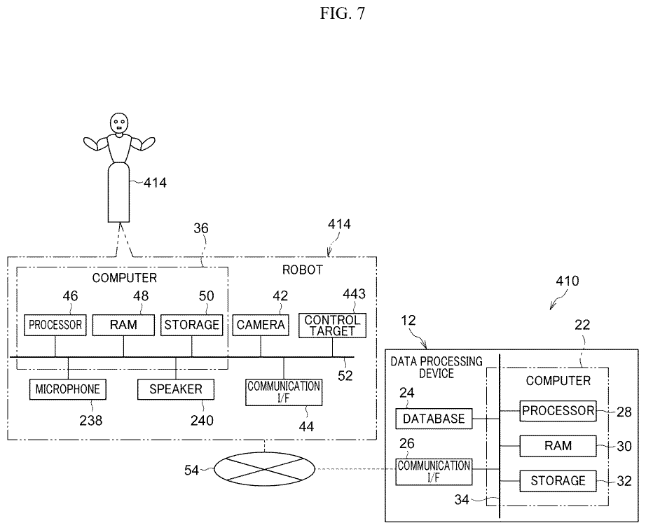

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

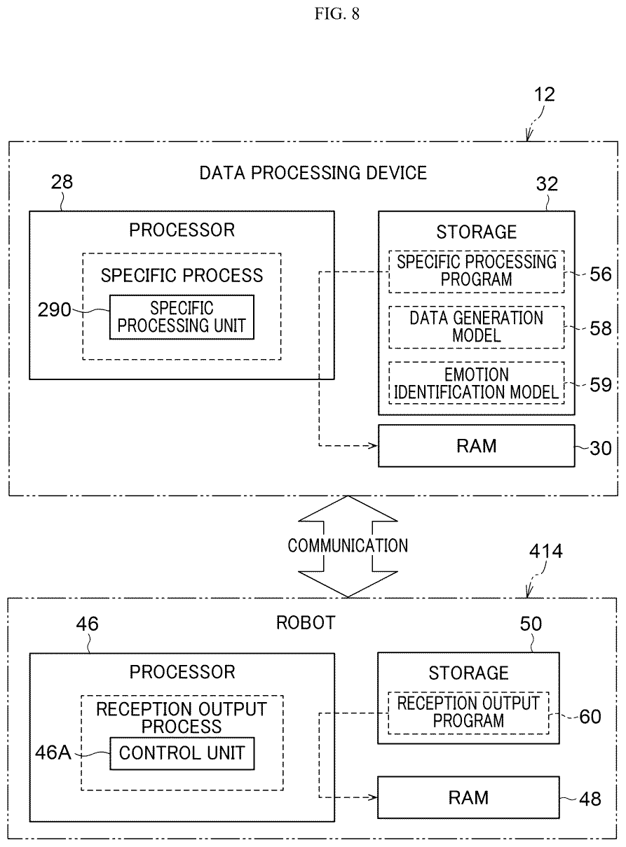

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

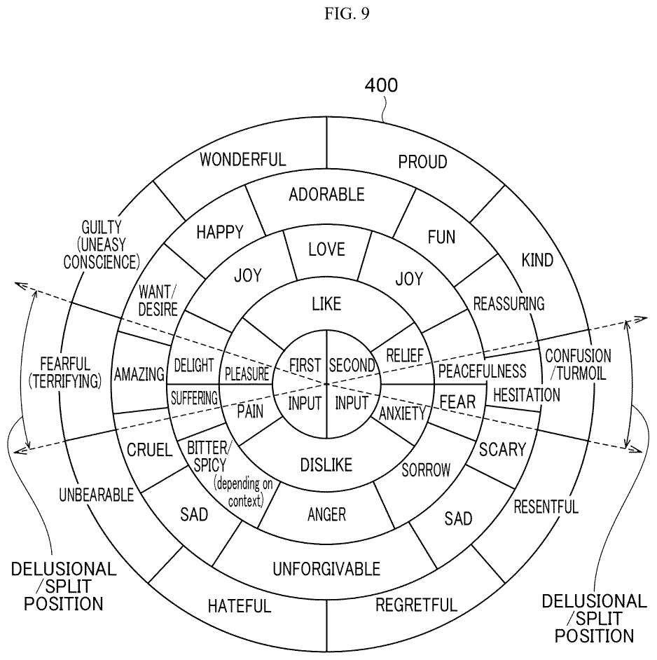

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

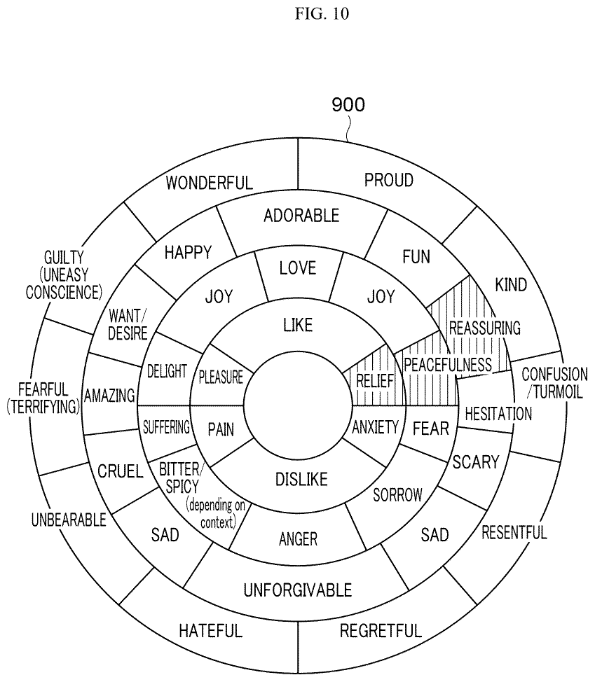

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
provide a user interface that enables a user to input activity information or movement information as text data by using a general-purpose information processing apparatus, convert the text data into structured data with order information, and display the structured data as list information, and
detect a drag-and-drop operation by the user on the list information, update the order information of the structured data according to the drag-and-drop operation, and automatically generate a baseline plan by calculating a start time and an end time for each activity based on the updated order information using a time information calculation library so that the baseline plan is non-overlapping and falls within a predetermined time range, and
acquire, from a storage device, the baseline plan and past execution history data associated with the user, and aggregate behavior pattern information including tendency information of stay duration, tendency information of start time, and preferred time zone information for each type of activity based on the past execution history data, and
generate a prompt sentence including the list information, the baseline plan, and the behavior pattern information, describe in natural language within the prompt sentence a user-defined order maintenance condition, a predetermined time range constraint, and a waiting-time reduction condition, and input the prompt sentence into a generative AI model to obtain, from the generative AI model, an optimized plan including optimized start times and end times corresponding to the activities, and
verify that an order of the activities included in the optimized plan matches the user-defined order and that time information included in the optimized plan satisfies a predetermined format and the predetermined time range constraint and does not mutually overlap, and store, in the storage device, a verified optimized plan obtained by resolving inconsistencies, if any, through deterministic time correction processing, and
acquire the verified optimized plan, present the verified optimized plan on a display device of the general-purpose information processing apparatus in a time-axis display or a list display, and, when a re-editing operation of the verified optimized plan is accepted from the user,
generate, together with the behavior pattern information, a new prompt sentence for re-input to the generative AI model based on updated plan information and execute a re-optimization process.

### Supplementary 2

The system according to supplementary 1,
wherein the processor is configured to
generate the prompt sentence by extracting, from a plurality of instances of past execution history data of the user, statistical information including an average stay duration for each type of activity, a preferred start time range, and an activity-interval waiting time, converting the statistical information into behavior pattern summary information in natural language description, and automatically generating the prompt sentence for input to the generative AI model by combining the behavior pattern summary information with the list information and the baseline plan.

### Supplementary 3

The system according to supplementary 1,
wherein the processor is configured to
acquire priority information, constraint duration information, and prohibited time zone information specified by the user for the list information, embed the priority information, the constraint duration information, and the prohibited time zone information as constraint conditions in the prompt sentence so as to propose an optimal time zone based on schedule information of the user and list items, and input the prompt sentence into the generative AI model.

### Application Example 1

### Supplementary 1

A system comprising a processor,
wherein the processor is configured to
receive, from a terminal, activity information and destination information, store the activity information and the destination information as elements of an ordered set in a storage resource, and provide a user interface to the terminal so as to visually display the ordered set on the terminal,
receive, from the terminal, order information indicating a change of a relative positional relationship among the elements included in the ordered set, update ordinals or position identifiers associated with the elements of the ordered set based on the order information, and store an updated ordered set in the storage resource,
execute computation processing to calculate plan information including an execution order and an execution time for the elements based on an order of the elements included in the updated ordered set and attribute information associated with the elements, the computation processing using utilization efficiency of a delivery resource or a movement resource as an evaluation index, and generate the plan information as structured data and as a natural language expression that are transmittable to the terminal,
generate a prompt sentence based on the activity information, the destination information, the plan information, and execution history information of a user, input the prompt sentence to a generative information processing model, and generate an optimized plan reflecting a behavior tendency and a priority of the user by modifying or supplementing at least a part of the plan information based on a response acquired from the generative information processing model, and
receive, from the terminal, progress information indicating an execution status of each element included in the plan information, recalculate the plan information based on the progress information, and transmit updated plan information to the terminal so as to dynamically update the plan in accordance with an execution status of the user.

### Supplementary 2

The system according to supplementary 1,
wherein the processor is configured to
configure the prompt sentence input to the generative information processing model as a query that summarizes the execution history information of the user, a change history of the ordered set, and the progress information, and that extracts a behavior pattern and a preference tendency, and automatically adjust a weight or a priority parameter assigned to each element based on the response from the generative information processing model.

### Supplementary 3

The system according to supplementary 1,
wherein the processor is configured to
configure the prompt sentence input to the generative information processing model as a time allocation problem including required time information, location information, and resource constraint information associated with each element, and reflect, in the plan information, a recommended time period or a start time candidate obtained as the response from the generative information processing model, thereby automatically proposing the execution time so that utilization efficiency of a time resource of the user is increased.

### Example 2

### Supplementary 1

A system comprising a processor,
wherein the processor is configured to
provide a display screen as a user interface for displaying, in a list format, activity information input by a user through an information processing device,
execute processing for generating action plan information automatically based on an order of elements in the list, the order being changed by an operation input performed by the user,
acquire, from a user terminal, behavior history information of the user, utilization frequency information of the elements in the list, and time zone information, and store the behavior history information and the like,
execute machine learning processing that calculates behavior tendency information of the user by performing statistical processing using the stored behavior history information and the like, generates feature information based on the behavior tendency information and importance information given by the user, and constructs prediction model information by performing learning processing based on the feature information and execution state information,
calculate, based on the prediction model information, current date and time information, and element information included in the list, a suitability evaluation value for each element, and automatically adjust the order of the elements in the list according to the suitability evaluation value,
transmit updated list information, which is based on the automatically adjusted order, to the user terminal and cause the user terminal to display the updated list information,
generate a prompt sentence including summary information related to the behavior tendency information of the user, the utilization frequency information, and the time zone information, and including instruction content for optimizing the order of the elements in the list, and input the prompt sentence to a generative artificial intelligence model to acquire response information related to an improvement policy or explanatory information regarding the action plan information or the automatically adjusted order, and
correct the action plan information or order adjustment processing of the list based on the response information, or present the response information to the user.

### Supplementary 2

The system according to supplementary 1,
wherein the processor is configured to
generate the prompt sentence so as to include a question sentence for obtaining, from the generative artificial intelligence model, a method for optimizing the order of the elements in the list based on the behavior history information of the user, the utilization frequency information, and the time zone information, and proposals relating to the feature information and learning conditions used in the machine learning processing.

### Supplementary 3

The system according to supplementary 1,
wherein the processor is configured to
generate the prompt sentence so as to include a question sentence for causing the generative artificial intelligence model to output candidate time zones suitable for execution of each element and explanation of reasons therefor, based on schedule information of the user and the element information in the list, and to display, on the user terminal, the candidate time zones and the explanation of reasons in association with each element of the list.

### Application Example 2

### Supplementary 1

A system comprising a processor,
wherein the processor is configured to
provide, to an information processing device, a user interface that displays, in a list format, behavior information input by a user through the information processing device, and that allows the user to change an order of items in the list by a drag-and-drop operation,
transmit, via a communication line, list information after the order change and user identification information to a computation device, cause the computation device to store the list information in a storage device, cause the computation device to acquire past behavior history information and time-zone information of the user, cause the computation device to generate a behavior pattern model by performing machine learning processing using the past behavior history information and the time-zone information, and cause the computation device to execute calculation processing for predicting a display order and an execution time zone of the items in the list based on the behavior pattern model,
cause the computation device to generate a prompt sentence for a generative artificial intelligence model from summary explanation information obtained by summarizing the behavior history information, emotion state information, the time-zone information, and the list information, cause the computation device to input the prompt sentence into the generative artificial intelligence model, cause the computation device to acquire a recommended order and a recommended time zone from the generative artificial intelligence model, and cause the computation device to integrate the recommended order and the recommended time zone with a prediction result obtained by the machine learning processing to generate optimized plan information, and
transmit the optimized plan information to the information processing device, cause the information processing device to visually present, on the user interface, the display order of the items and the recommended time zone based on the optimized plan information, receive a correction operation from the user, transmit a correction result to the computation device as behavior history information, and cause the computation device to perform feedback processing in which the behavior pattern model and generation of the prompt sentence are updated based on the behavior history information.

### Supplementary 2

The system according to supplementary 1,
wherein the processor is configured to cause the computation device to use the behavior history information of the user, correction operation information, emotion state information, and execution result information as learning data, to execute, in parallel with learning processing of the behavior pattern model, a prompt optimization processing that updates configuration elements and weighting of the prompt sentence to be input into the generative artificial intelligence model.

### Supplementary 3

The system according to supplementary 1,
wherein the processor is configured to cause the computation device to generate a feature set by integrating schedule information of the user, item information in the list, the behavior history information, the emotion state information, and environment information acquired from an external information providing device, to generate a prompt sentence including the feature set, to input the prompt sentence into the generative artificial intelligence model so that the generative artificial intelligence model generates candidate time zones for activities, and to combine the candidate time zones with time-zone-dependent selection probabilities calculated by the machine learning processing so as to propose an optimal time zone to the user.

What is claimed is:

1. A system comprising:
a communication interface coupled to a packet-switched network; and
circuitry configured to:
provide, to a terminal device via the communication interface, a user interface enabling a user to input item information as text data, convert the text data into structured data with order information, and display the structured data as list information;
detect reordering operations performed by the user on the list information, update the order information of the structured data in response to the reordering operations, and automatically generate a baseline plan by calculating a start time and an end time for each item based on the updated order information such that the baseline plan is non-overlapping and falls within a predetermined time range;
acquire, from a storage device, the baseline plan and past execution history data associated with the user, and aggregate behavior pattern information comprising tendency information of duration, tendency information of start time, and preferred time zone information for each type of item;
generate a prompt comprising the list information, the baseline plan, and the behavior pattern information, and input the prompt to a generative neural network model to obtain an optimized plan comprising optimized start times and end times for the items; and
verify that an order of items in the optimized plan matches a user-defined order, that time information satisfies the predetermined time range constraint and does not mutually overlap, perform deterministic time correction processing to resolve any inconsistency, and store a verified optimized plan in the storage device.

2. The system according to claim 1, wherein the circuitry is further configured to calculate the start time and the end time for each item in the baseline plan using a time information calculation library that allocates contiguous time slots in the user-defined order with default durations derived from item type classifications.

3. The system according to claim 2, wherein the behavior pattern information is aggregated from the past execution history data by computing, for each item type, a mean duration, a standard deviation of duration, a most frequent start time, and a frequency distribution across time zones.

4. The system according to claim 3, wherein the prompt further comprises, in natural language, an order maintenance condition specifying that the user-defined order must be preserved, the predetermined time range constraint specifying earliest start and latest end boundaries, and a waiting-time reduction condition specifying minimization of idle intervals between consecutive items.

5. The system according to claim 4, wherein the generative neural network model generates the optimized plan by processing the prompt through a transformer architecture comprising attention layers that evaluate pairwise temporal relationships among the items and output time-slot assignments conditioned on the behavior pattern information and the constraints.

6. The system according to claim 5, wherein the deterministic time correction processing comprises sequential validation of each time slot against the constraints, shifting start times forward when overlap is detected, and truncating end times when the predetermined time range boundary is exceeded.

7. The system according to claim 1, wherein the circuitry is further configured to present the verified optimized plan on the terminal device in at least one of a time-axis display and a list display, and to receive re-editing input from the terminal device specifying modifications to one or more time slots.

8. The system according to claim 7, wherein the circuitry is further configured to generate an updated prompt comprising the re-editing input and the verified optimized plan, input the updated prompt to the generative neural network model, obtain a revised optimized plan, and apply the verification and correction processing to the revised plan.

9. The system according to claim 8, wherein the circuitry is further configured to compare the revised optimized plan with the prior verified optimized plan to identify changed time slots, and to highlight the changed time slots in the display on the terminal device.

10. The system according to claim 1, wherein the circuitry is further configured to acquire location data associated with each item from the structured data, calculate estimated travel durations between consecutive items based on location data and a routing algorithm, and include the estimated travel durations in the prompt as inter-item transition constraints.

11. The system according to claim 10, wherein the routing algorithm queries a mapping service via the packet-switched network to obtain distance and travel time estimates based on a selected transportation mode.

12. The system according to claim 1, wherein the circuitry is further configured to detect that a current time exceeds a scheduled start time for an item in the verified optimized plan, generate a notification message, and transmit the notification to the terminal device via the packet-switched network.

13. The system according to claim 12, wherein the circuitry is further configured to re-optimize remaining items in the plan when a detected delay exceeds a threshold by generating a re-optimization prompt comprising the current time, completed items, and remaining items, and inputting the prompt to the generative neural network model.

14. The system according to claim 1, wherein the circuitry is further configured to perform emotion estimation processing on text input received from the terminal device and to adjust a priority weighting parameter in the prompt based on the estimated emotional state.

15. The system according to claim 1, wherein the circuitry is further configured to record actual execution times for items from the terminal device and to update the past execution history data in the storage device, thereby refining the behavior pattern information for subsequent plan optimizations.

16. The system according to claim 1, wherein the item information comprises activities and destinations input by a user, the baseline plan comprises a daily schedule, and the behavior pattern information comprises historical preferences for activity sequencing and timing.

17. The system according to claim 16, wherein the circuitry is further configured to calculate a plan adherence rate based on a ratio of items completed within their optimized time slots to total items over a measurement period, and to adjust prompt-generation parameters when the adherence rate falls below a threshold.

18. A system comprising:
a communication interface coupled to a packet-switched network; and
circuitry configured to:
provide a user interface to a terminal device for inputting item information, convert the information into structured data with order information, and detect reordering operations to update the order;
generate a baseline plan by calculating non-overlapping start and end times for items using a time calculation library with default durations, and acquire past execution history data from a storage device to aggregate behavior pattern information comprising mean duration, start time tendency, and time zone frequency for each item type;
generate a prompt comprising the structured data, the baseline plan, the behavior pattern information, an order maintenance condition, a time range constraint, a waiting-time reduction condition, and estimated travel durations derived from location data and a routing algorithm;
input the prompt to a generative neural network model to obtain an optimized plan, verify order compliance, time format validity, non-overlap, and time range compliance, perform deterministic correction to resolve inconsistencies, and store the verified plan;
present the verified plan on the terminal device and receive re-editing input, generate an updated prompt, obtain a revised plan, and apply verification and correction; and
record actual execution times, update the execution history data, and re-optimize remaining items when delays are detected.

19. The system according to claim 18, wherein the circuitry is further configured to compare the revised optimized plan with the prior plan, highlight changed time slots on the terminal device, and transmit notification messages when scheduled start times are exceeded.

20. A method comprising:
providing, by circuitry coupled to a packet-switched network, a user interface to a terminal device for inputting item information, converting the information into structured data with order information, and detecting reordering operations;
generating a baseline plan by calculating non-overlapping start and end times based on the order information;
acquiring past execution history data from a storage device and aggregating behavior pattern information;
generating a prompt comprising the structured data, the baseline plan, and the behavior pattern information, and inputting the prompt to a generative neural network model to obtain an optimized plan; and
verifying order compliance and time constraints of the optimized plan, performing deterministic time correction, and storing a verified optimized plan in the storage device.
